(19) United States
(12) Patent Application Publication
(10) Pub. No.: US 2026/0323096 A1
(43) Pub. Date: Oct. 15, 2026

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Zhipin DENG, Beijing (CN); Kai ZHANG, Los Angeles, CA (US); Li ZHANG, Los Angeles, CA (US)

(21) Appl. No.: 19/693,114

(22) Filed: May 29, 2026

Related U.S. Application Data
(63) Continuation of application No. PCT/CN2024/135065, filed on Nov. 27, 2024.

(30) Foreign Application Priority Data
Nov. 29, 2023 (WO) PCT/CN2023/135252

(51) Int. Cl. H04N 19/80; H04N 19/117; H04N 19/159; H04N 19/176

(52) U.S. Cl. CPC H04N 19/80; H04N 19/117; H04N 19/159; H04N 19/176

(57) ABSTRACT

Embodiments of the present disclosure provide a solution for video processing. In a method for video processing, for a conversion between a current video unit of a video and a bitstream of the video, an indicator of a low-pass filter of the current video unit is determined by inheriting from a previous coded block. The low-pass filter is applied to the current video unit based on the indicator. The conversion is performed based on the applying.

### CROSS-REFERENCE TO RELATED APPLICATIONS

This application is a continuation of International Application No. PCT/CN2024/135065, filed on Nov. 27, 2024, which claims the benefit of International Application No. PCT/CN2023/135252 filed on Nov. 29, 2023. The entire contents of these applications are hereby incorporated by reference in their entireties.

### FIELDS

Embodiments of the present disclosure relate generally to video processing techniques, and more particularly, to low-pass filter for video processing.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a current video unit of a video and a bitstream of the video, an indicator of a low-pass filter of the current video unit by inheriting from a previous coded block; applying the low-pass filter to the current video unit based on the indicator; and performing the conversion based on the applying. The method in accordance with the first aspect of the present disclosure inherits the indicator of low-pass filer from the previous coded block, and thus improves the video coding performance.

In a second aspect, another method for video processing is proposed. The method comprises: applying, for a conversion between a current video unit of a video and a bitstream of the video, a low-pass filter to the current video unit coded in a fusion mode; and performing the conversion based on the applying. The method in accordance with the second aspect of the present disclosure apples the low-pass filter for the video unit coded in a fusion mode, and thus improves the video coding performance.

In a third aspect, another method for video processing is proposed. The method comprises: performing a conversion between a current video unit of a video and a bitstream of the video by applying a low-pass filter to the current video unit; and storing information associated with the low-pass filter in at least one of: a temporal buffer, or a history buffer. The method in accordance with the third aspect of the present disclosure stores the information of the low-pass filer which may be applied for coding further coding blocks, and thus improves the video coding performance.

In a fourth aspect, another method for video processing is proposed. The method comprises: determining, for a conversion between a current video unit of a video and a bitstream of the video, a first candidate and a second candidate of the current video unit, the first and second candidates being motion candidates or cross-component prediction (CCP) candidates; performing a pruning process on the first and second candidates based on a first indicator of a low-pass filter associated with the first candidate and a second indicator of the low-pass filter associated with the second candidate; and performing the conversion based on the pruning process. The method in accordance with the fourth aspect of the present disclosure performs the pruning process for motion or CCP candidates considering the applying of low-pass filer, and thus improves the video coding performance.

In a fifth aspect, another method for video processing is proposed. The method comprises: applying, for a conversion between a current video unit of a video and a bitstream of the video, a first low-pass filter to template samples of the current video unit to obtain filtered template samples; determining a usage of a second low-pass filter for the current video unit based on the filtered template samples; and performing the conversion based on the usage of the second low-pass filter. The method in accordance with the fifth aspect of the present disclosure determines the usage of the low-pass filer using a template based method, and the templates samples are filtered by another low-pass filter, and thus improves the video coding performance.

In a sixth aspect, an apparatus for video processing is proposed. The apparatus comprises a processor and a non-transitory memory with instructions thereon. The instructions upon execution by the processor, cause the processor to perform a method in accordance with the first, second, third, fourth, or fifth aspect of the present disclosure.

In a seventh aspect, a non-transitory computer-readable storage medium is proposed. The non-transitory computer-readable storage medium stores instructions that cause a processor to perform a method in accordance with the first, second, third, fourth, or fifth aspect of the present disclosure.

In an eighth aspect, another non-transitory computer-readable recording medium is proposed. The non-transitory computer-readable recording medium stores a bitstream of a video which is generated by a method performed by an apparatus for video processing. The method comprises: determining an indicator of a low-pass filter of a current video unit of the video by inheriting from a previous coded block; applying the low-pass filter to the current video unit based on the indicator; and generating the bitstream based on the applying.

In a ninth aspect, another non-transitory computer-readable recording medium is proposed. The non-transitory computer-readable recording medium stores a bitstream of a video which is generated by a method performed by an apparatus for video processing. The method comprises: applying a low-pass filter to a current video unit of the video, the current video unit being coded in a fusion mode; and generating the bitstream based on the applying.

In a tenth aspect, another non-transitory computer-readable recording medium is proposed. The non-transitory computer-readable recording medium stores a bitstream of a video which is generated by a method performed by an apparatus for video processing. The method comprises: generating the bitstream by applying a low-pass filter to a current video unit of the video; and storing information associated with the low-pass filter in at least one of: a temporal buffer, or a history buffer.

In an eleventh aspect, another non-transitory computer-readable recording medium is proposed. The non-transitory computer-readable recording medium stores a bitstream of a video which is generated by a method performed by an apparatus for video processing. The method comprises: determining a first candidate and a second candidate of a current video unit of the video, the first and second candidates being motion candidates or cross-component prediction (CCP) candidates; performing a pruning process on the first and second candidates based on a first indicator of a low-pass filter associated with the first candidate and a second indicator of the low-pass filter associated with the second candidate; and generating the bitstream based on the pruning process.

In a twelfth aspect, another non-transitory computer-readable recording medium is proposed. The non-transitory computer-readable recording medium stores a bitstream of a video which is generated by a method performed by an apparatus for video processing. The method comprises: applying a first low-pass filter to template samples of a current video unit of the video to obtain filtered template samples; determining a usage of a second low-pass filter for the current video unit based on the filtered template samples; and generating the bitstream based on the usage of the second low-pass filter.

In a thirteenth aspect, a method for storing a bitstream of a video is proposed. The method comprises: determining an indicator of a low-pass filter of a current video unit of the video by inheriting from a previous coded block; applying the low-pass filter to the current video unit based on the indicator; generating the bitstream based on the applying; and storing the bitstream in a non-transitory computer-readable recording medium.

In a fourteenth aspect, a method for storing a bitstream of a video is proposed. The method comprises: applying a low-pass filter to a current video unit of the video, the current video unit being coded in a fusion mode; generating the bitstream based on the applying; and storing the bitstream in a non-transitory computer-readable recording medium.

In a fifteenth aspect, a method for storing a bitstream of a video is proposed. The method comprises: generating the bitstream by applying a low-pass filter to a current video unit of the video; storing information associated with the low-pass filter in at least one of: a temporal buffer, or a history buffer; and storing the bitstream in a non-transitory computer-readable recording medium.

In a sixteenth aspect, a method for storing a bitstream of a video is proposed. The method comprises: determining a first candidate and a second candidate of a current video unit of the video, the first and second candidates being motion candidates or cross-component prediction (CCP) candidates; performing a pruning process on the first and second candidates based on a first indicator of a low-pass filter associated with the first candidate and a second indicator of the low-pass filter associated with the second candidate; generating the bitstream based on the pruning process; and storing the bitstream in a non-transitory computer-readable recording medium.

In a seventeenth aspect, a method for storing a bitstream of a video is proposed. The method comprises: applying a first low-pass filter to template samples of a current video unit of the video to obtain filtered template samples; determining a usage of a second low-pass filter for the current video unit based on the filtered template samples; generating the bitstream based on the usage of the second low-pass filter; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4A illustrates an illustration of the effect of the slope adjustment parameter “u” with a model created with the current CCLM;

FIG. 4B illustrates an illustration of the effect of the slope adjustment parameter “u” with a model updated as proposed;

FIG. 5 illustrates neighboring blocks (L, A, BL, AR, AL) used in the derivation of a general MPM list;

FIG. 6 illustrates neighboring reconstructed samples used for DIMD chroma mode;

FIG. 7 illustrates intra template matching search area used;

FIG. 8 illustrates the use of IntraTMP block vector for IBC block;

FIG. 9A and FIG. 9B illustrate the division method for angular modes, respectively;

FIG. 10 illustrates extended MRL candidate list;

FIG. 11 illustrates an illustration of the template area;

FIG. 12 illustrates spatial part of the convolutional filter;

FIG. 13 illustrates reference area (with its paddings) used to derive the filter coefficients;

FIG. 14 illustrates four Sobel based gradient patterns for GLM;

FIG. 15 illustrates non-downsampled luma samples;

FIG. 16 illustrates a reference area for BVG-CCCM;

FIG. 17 illustrates spatial samples used for GL-CCCM;

FIG. 18 illustrates various downsampling filters used in cross-component models;

FIG. 19 illustrates a filter on samples of MM-CCLM/MM-CCCM;

FIG. 20 illustrates spatial GPM candidates;

FIG. 21 illustrates an GPM template;

FIG. 22 illustrates an GPM blending;

FIG. 23 illustrates a transform selection process for directional planar modes;

FIG. 24 illustrates luma blocks used to derive direct block vector;

FIG. 25A to FIG. 25C illustrate examples of prediction for different positions in the current block, respectively;

FIG. 26 illustrates the defined three types of reconstructed areas include thirteen columns or rows of reconstructed pixels;

FIG. 27 illustrates the defined three types of filter shapes have fifteen inputs and generate one output;

FIG. 28A to FIG. 28C illustrate examples of prediction for different positions in the current block, respectively;

FIG. 29 illustrates the InterCCCM method on the decoder;

FIG. 30 illustrates luma samples L0, . . . , L5 in relation to the chroma sample C;

FIG. 31 illustrates a reference area for BVG-CCCM;

FIG. 32 illustrates a spatial part of the convolutional filter;

FIG. 33 illustrates locations used for block vector derivation from co-located luma block;

FIG. 34 illustrates a flowchart of a method for video processing in accordance with embodiments of the present disclosure;

FIG. 35 illustrates a flowchart of another method for video processing in accordance with embodiments of the present disclosure;

FIG. 36 illustrates a flowchart of another method for video processing in accordance with embodiments of the present disclosure;

FIG. 37 illustrates a flowchart of another method for video processing in accordance with embodiments of the present disclosure;

FIG. 38 illustrates a flowchart of another method for video processing in accordance with embodiments of the present disclosure; and

FIG. 39 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

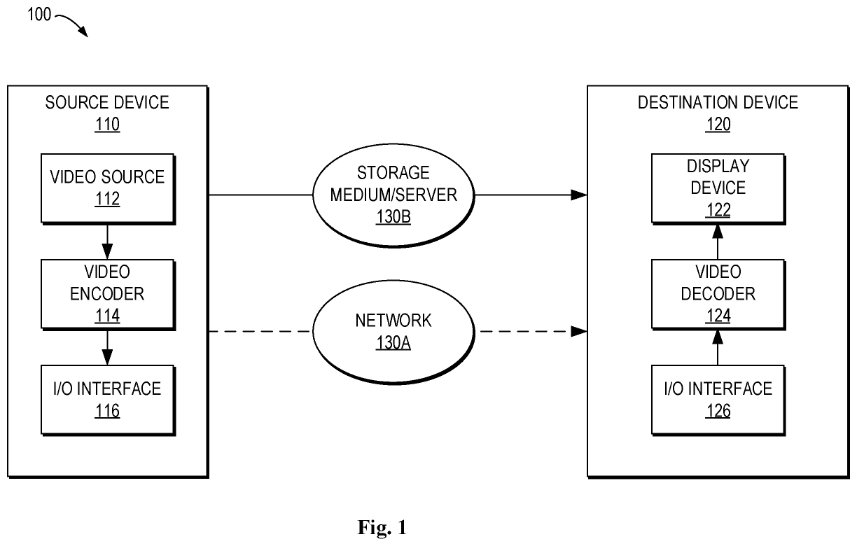

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

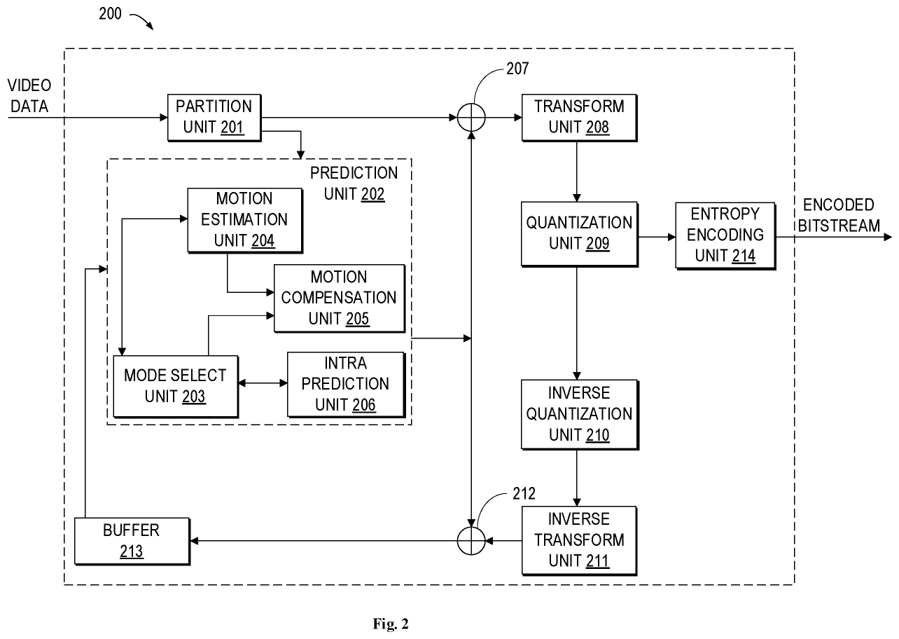

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

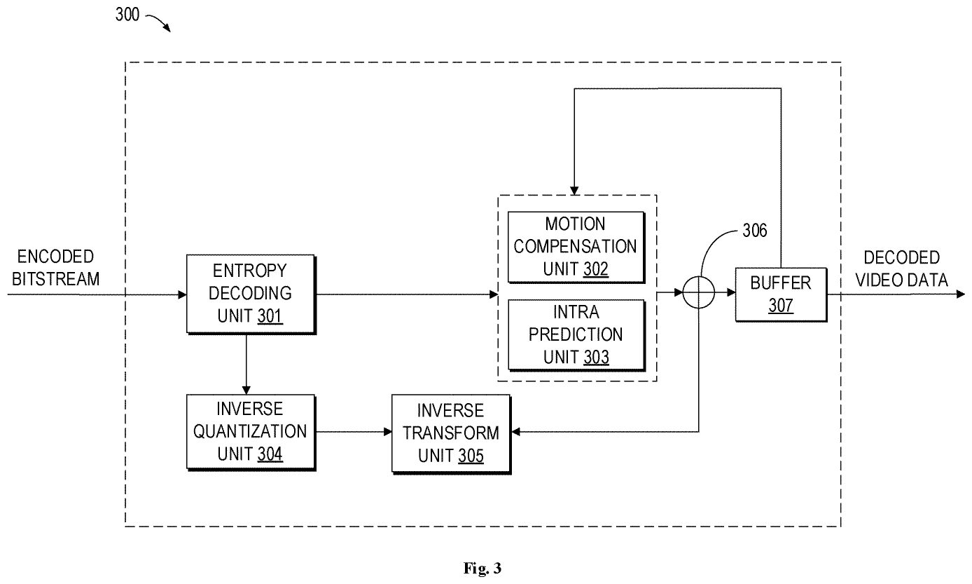

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1 BRIEF SUMMARY

This disclosure is related to video coding technologies. Specifically, it is about the usage of a low pass filtering in image/video coding. It may be applied to the existing video coding standard like HEVC, VVC, and etc. It may be also applicable to future video coding standards or video codec.

### 2 INTRODUCTION

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 WET meeting, and the first version of VVC test model (VTM) was released at that time. The VVC working draft and test model VTM are then updated after every meeting. The VVC project achieved technical completion (FDIS) at the July 2020 meeting.

### 2.1 Intra Prediction

In intra prediction the smallest chroma intra prediction unit (SCIPU) constraint in VVC is removed. In addition, the VPDU constraint for reducing CCLM prediction latency is also removed.

### 2.1.1 Multi-Model LM (MMLM)

CCLM included in VVC is extended by adding three Multi-model LM (MMLM) modes. In each MMLM mode, the reconstructed neighboring samples are classified into two classes using a threshold which is the average of the luma reconstructed neighboring samples. The linear model of each class is derived using the Least-Mean-Square (LMS) method. For the CCLM mode, the LMS method is also used to derive the linear model. A slope adjustment to is applied to cross-component linear model (CCLM) and to Multi-model LM prediction. The adjustment is tilting the linear function which maps luma values to chroma values with respect to a center point determined by the average luma value of the reference samples.

### 2.1.1.1 Slope Adjustment of CCLM

CCLM uses a model with 2 parameters to map luma values to chroma values. The slope parameter “a” and the bias parameter “b” define the mapping as follows:

chromaVal=a*lumaVal+b.

An adjustment “u” to the slope parameter is signaled to update the model to the following form:

chromaVal=a′*lumaVal+b′,

where

a′=a+u,

b′=b−u*yr.

With this selection the mapping function is tilted or rotated around the point with luminance value yr. The average of the reference luma samples used in the model creation as yr in order to provide a meaningful modification to the model. Picture below illustrates the process.

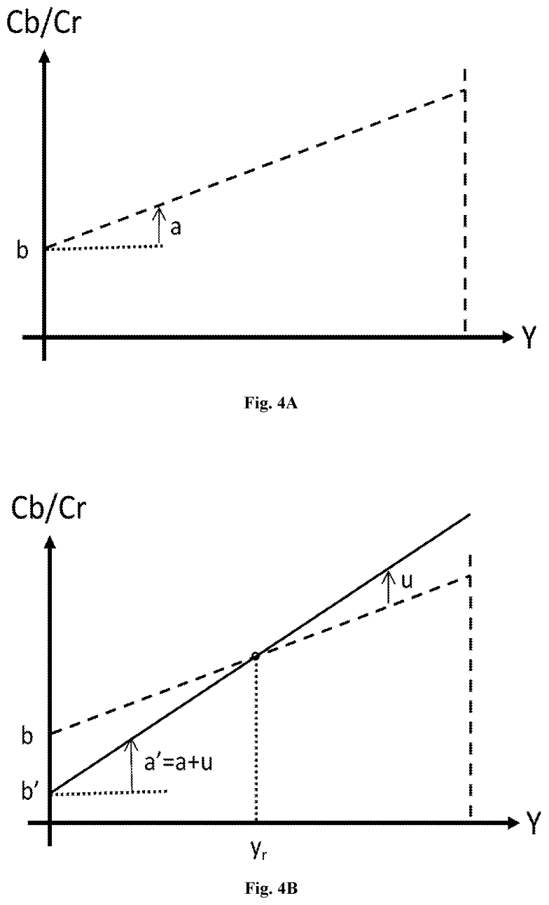

FIG. 4A illustrates an illustration of the effect of the slope adjustment parameter “u” with a model created with the current CCLM.

FIG. 4B illustrates an illustration of the effect of the slope adjustment parameter “u” with a model updated as proposed.

### Implementation

Slope adjustment parameter is provided as an integer between −4 and 4, inclusive, and signaled in the bitstream. The unit of the slope adjustment parameter is ⅛^{th} of a chroma sample value per one luma sample value (for 10-bit content).

Adjustment is available for the CCLM models that are using reference samples both above and left of the block (“LM_CHROMA_IDX” and “MMLM_CHROMA_IDX”), but not for the “single side” modes. This selection is based on coding efficiency vs. complexity trade-off considerations.

When slope adjustment is applied for a multimode CCLM model, both models can be adjusted and thus up to two slope updates are signaled for a single chroma block.

### Encoder Approach

The proposed encoder approach performs an SATD based search for the best value of the slope update for Cr and a similar SATD based search for Cb. If either one results as a non-zero slope adjustment parameter, the combined slope adjustment pair (SATD based update for Cr, SATD based update for Cb) is included in the list of RD checks for the TU.

### 2.1.2 Gradient PDPC

In VVC, for a few scenarios, PDPC may not be applied due to the unavailability of the secondary reference samples. In these cases, a gradient based PDPC, extended from horizontal/vertical mode, is applied. The PDPC weights (wT/wL) and nScale parameter for determining the decay in PDPC weights with respect to the distance from left/top boundary are set equal to corresponding parameters in horizontal/vertical mode, respectively. When the secondary reference sample is at a fractional sample position, bilinear interpolation is applied.

### 2.1.3 Primary and Secondary MPM

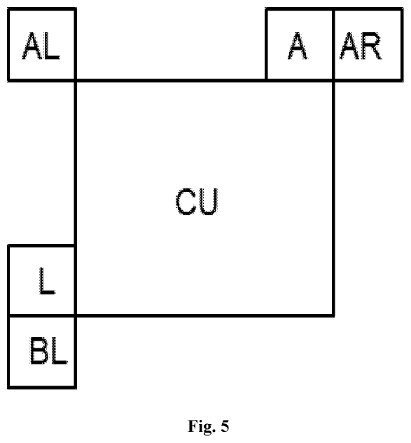

Secondary MPM lists is introduced. The existing primary MPM (PMPM) list consists of 6 entries and the secondary MPM (SMPM) list includes 16 entries. A general MPM list with 22 entries is constructed first, and then the first 6 entries in this general MPM list are included into the PMPM list, and the rest of entries form the SMPM list. The first entry in the general MPM list is the Planar mode. The remaining entries are composed of the intra modes of the left (L), above (A), below-left (BL), above-right (AR), and above-left (AL) neighbouring blocks as shown in FIG. 5, and DIMD modes which are sorted in ascending order of SAD cost. Up to 5 modes with the smallest SAD cost are added. The SAD cost is computed between the prediction and the reconstruction samples of the template. The sorted directional modes with added offset are added into the general MPM list, and then the default modes, until the general MPM list with 22 entries is constructed.

If a CU block is vertically oriented, the order of neighbouring blocks is A, L, BL, AR, AL; otherwise, it is L, A, BL, AR, AL.

MPM list is equally divided into four groups and the group index is parsed first. Then, a mode index is further parsed to indicate which mode in the selected group is used.

### 2.1.4 Reference Sample Interpolation and Smoothing for Intra-Prediction

The 4-tap cubic interpolation is replaced with a 6-tap cubic interpolation filter, for the derivation of predicted samples from the reference samples.

For reference sample filtering, a 6-tap gaussian filter is applied for larger blocks (W>=32 and H>=32), existing VVC 4-tap gaussian interpolation filter is applied otherwise. The extended intra reference samples are derived using the 4-tap interpolation filter instead of the nearest neighbor rounding.

### 2.1.5 Decoder Side Intra Mode Derivation (DIMD)

When DIMD is applied, up to five intra modes are derived from the reconstructed neighbor samples, and those five predictors are combined with the planar mode predictor with the weights derived from the histogram of gradients. The division operations in weight derivation are performed utilizing the same lookup table (LUT) based integerization scheme used by the CCLM. For example, the division operation in the orientation calculation

Orient=G_{y}/Gₓ

is computed by the following LUT-based scheme:

x=Floor(Log 2(Gx))

normDiff=((Gx<<4)x)&15

x+=(3+(normDiff!=0)?1:0)

Orient=(Gy*(DivSigTable[normDiff]8)+(1<<(x−1)))x

where

DivSigTable[16]={0,7,6,5,5,4,4,3,3,2,2,1,1,1,1,0}.

For a block of size W×H, the weight for each of the five derived modes is modified if the one the above or left histogram magnitudes is twice larger than the other one. In this case, the weights are location dependent and computed as follows:

If the above histogram is twice the left, then:

$${w}_{i} ( x , y ) = wDim {d}_{i} + {Δ}_{i} - 2 {Δ}_{i} \frac{y}{( H - 1 )} .$$

If the left histogram is twice the above, then:

$${w}_{i} ( x , y ) = wDim {d}_{i} + {Δ}_{i} - 2 {Δ}_{i} \frac{x}{( W - 1 )} ,$$

where wDimdᵢ is the unmodified uniform weight of the DIMD selected, Δᵢ is pre-defined and set to 10. Derived intra modes are included into the primary list of intra most probable modes (MPM), so the DIMD process is performed before the MPM list is constructed. The primary derived intra mode of a DIMD block is stored with a block and is used for MPM list construction of the neighboring blocks. Finally, note the region of neighboring reconstructed samples used for computing the histogram of gradients is modified compared to the method described above, depending on reconstructed samples availability. The region of decoded reference samples of current W×H luma CB is extended towards the above-right side if available, up to W additional columns. It is extended towards the bottom-left side if available, up to H additional rows.

### 2.1.5.1 DIMD Chroma Mode

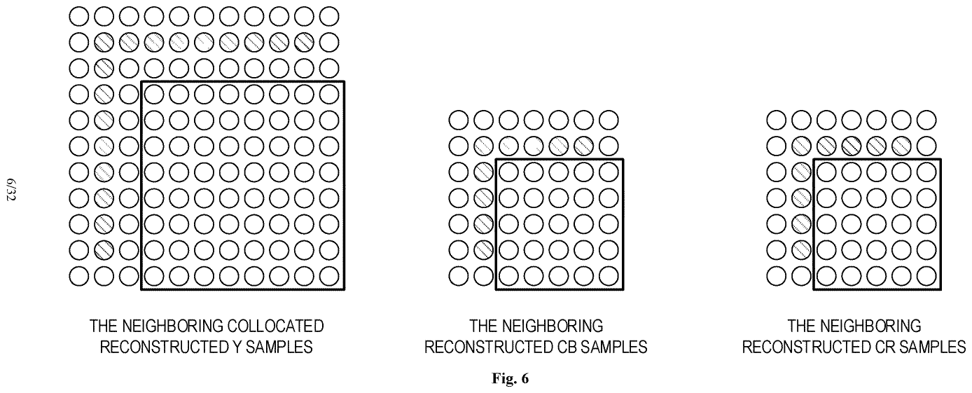

The DIMD chroma mode uses the DIMD derivation method to derive the chroma intra prediction mode of the current block based on the neighboring reconstructed Y, Cb and Cr samples in the second neighboring row and column as shown in FIG. 6. Specifically, a horizontal gradient and a vertical gradient are calculated for each collocated reconstructed luma sample of the current chroma block, as well as the reconstructed Cb and Cr samples, to build a HoG. Then the intra prediction mode with the largest histogram amplitude values is used for performing chroma intra prediction of the current chroma block.

When the intra prediction mode derived from the DIMD chroma mode is the same as the intra prediction mode derived from the DM mode, the intra prediction mode with the second largest histogram amplitude value is used as the DIMD chroma mode. A CU level flag is signaled to indicate whether the proposed DIMD chroma mode is applied.

Finally, the luma region of reconstructed samples used for computing the histogram of gradients for chroma DIMD mode is modified. For a W×H pair of chroma CBs to predict, to build the histogram of gradients associated to the collocated luma CB, the pairs of a vertical gradient and a horizontal gradient are extracted from the second and third lines in this luma CB instead of being extracted from the regular set of DIMD decoded reference samples around this luma CB.

### 2.1.6 Fusion of Chroma Intra Prediction Modes

In ECM, two chroma intra prediction signals can be fused together. One of the two chroma intra prediction signals is predicted using one of the DM mode, DIMD chroma mode and the four default modes (non-LM mode). The other chroma intra prediction signal is predicted using cross-component linear prediction modes (LM mode). Two different methods are supported.

In the first method, the LM mode can be either MM-CCLM or MM-CCCM, and the final predictor is derived as follows:

pred_{C}(i,j)=(w0×pred0(i,j)+w1×pred1(i,j)+(1<<(shift−1)))>>shift

where pred0(i,j) is the predictor obtained by applying the non-LM mode, pred1(i,j) is the predictor obtained by applying the LM mode and pred_{C}(i,j) is the final predictor of the current chroma block. The two weights, w0 and w1 are determined by the intra prediction mode of adjacent chroma blocks and shift is set equal to 2. Specifically, when the above and left adjacent blocks are both coded with LM modes, {w0, w1}={1, 3}; when the above and left adjacent blocks are both coded with non-LM modes, {w0, w1}={3, 1}; otherwise, {w0, w1}={2, 2}. Two template costs are calculated by fusing the angular chroma prediction with MM-CCLM or MM-CCCM, respectively, and the one of the two CCPs which provides a smaller template cost is utilized to derive pred1.

In the second method, the LM mode can be either MMLM or CCLM mode, and the final predictor is derived as follows:

pred_{C}(i,j)=α₀×pred0(i,j)+α₁×rec_{L}′(i,j)+α₂×β

where pred0(i,j) is the predictor obtained by applying the non-LM mode, rec_{L}′(i,j) is the set of downsampled reconstructed luma samples at co-located positions and pred_{C}(i,j) is the final predictor of the current chroma block. β is a fixed value and is set equal to 512 for 10-bit content. The three weights, α₀, α₁ and α₂ are derived from the adjacent luma and chroma samples using the same LDL derivation method as in CCCM.

For the syntax design, one index is signaled to indicate whether fusion is applied and which method is used. It is noted that for I slices, the non-LM mode can be DM mode, DIMD chroma mode and the four default modes. For non-I slices, only DIMD chroma mode is allowed to be fused with LM modes.

| Index value | Name |
|---|---|
| 0 | No fusion |
| 1 | First method |
| 2 | Second method with CCLM |
| 3 | Second method with MMLM |

### 2.1.7 Intra Template Matching

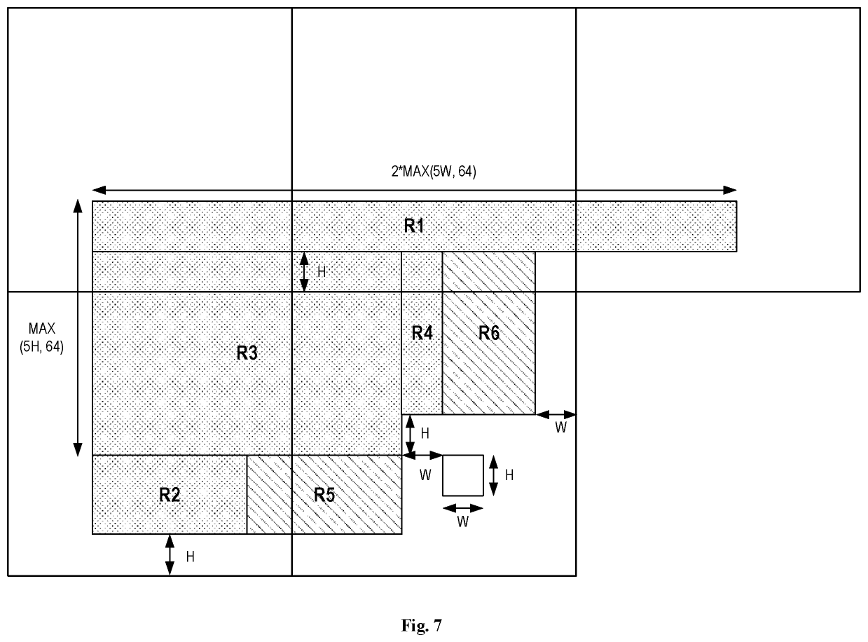

Intra template matching prediction (IntraTMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side. The prediction signal is generated by matching the L-shaped, Top-only or Left-Only causal neighbor of the current block with another block in a predefined search area in FIG. 7. There are 6 predefined search areas, i.e., R1 to R6 which contain the reconstructed samples from the top and left CTUs as well as part of the reconstructed samples within the current CTU that are located above, left, bottom-left and top-right to the current block.

Sum of absolute differences (SAD) is used as a cost function.

A given search order of the 6 regions is utilized, i.e., R4, R5, R6, R1, R2, and R3. Within each region, the decoder constructs a candidate list of up to “19” template matching block vectors that are ranked in ascending order according to the template cost (SAD). The following modes are supported:
1—Single predictor: A single predictor is selected from the candidate list.
2—Fusion of multiple predictors: multiple predictors are blended multiple to derive the final prediction block. The blending weights are either computed from the template matching cost of each predictor, or with Wiener-filter based weight derivation method.
3—Sub-pel precision: When single predictor is used, sub-pel precision can be used with ½-pel precision, ¼-pel precision and ¾-pel precision, each with 8 possible directions.
4—linear filter model: A linear filter can be learned between the reference template and current template and be applied the linear model to reference block. This mode can be used for single predictor when sub-pel precision is not used.

The dimensions of all regions (SearchRange_w, SearchRange_h) are set proportional to the block dimension (BlkW, BlkH) to have a fixed number of SAD comparisons per pixel. That is:

SearchRange_w=min(64,a*BlkW),

SearchRange_h=min(64,a*BlkH).

Where ‘a’ is a constant that controls the gain/complexity trade-off. In practice, ‘a’ is equal to 5.

To speed-up the template matching process, the search range of all search regions is subsampled by a factor of 3. After finding the best match, a refinement process is performed. The refinement is done via a second template matching search around the best match with a reduced range.

The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.

### 2.1.7.1 IntraTMP Derived Block Vector Candidates for IBC

In this method block vector (BV) derived from the intra template matching prediction (IntraTMP) is used for intra block copy (IBC). The stored IntraTMP BV of the neighbouring blocks along with IBC BV are used as spatial BV candidates in IBC candidate list construction.

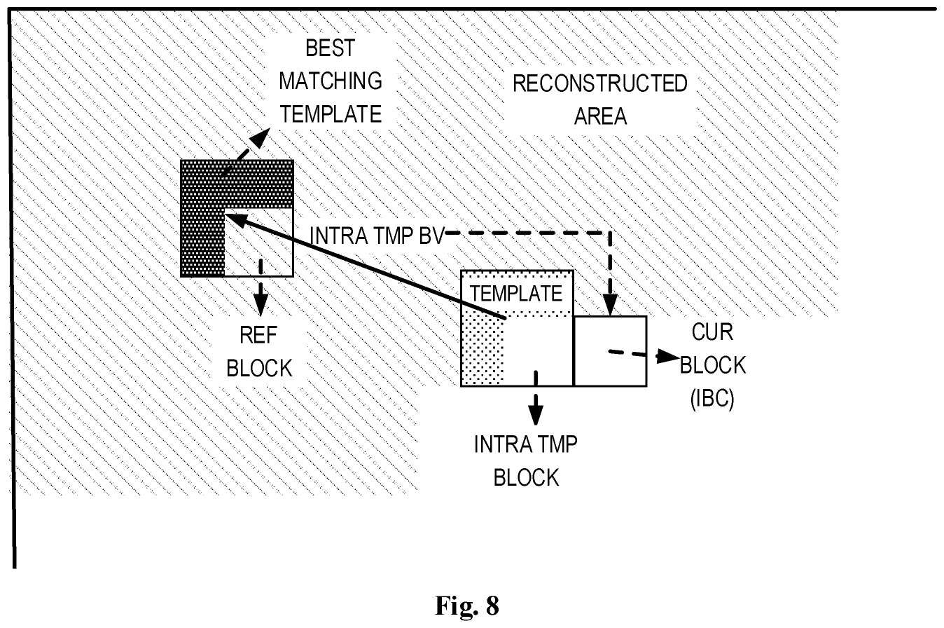

IntraTMP block vector is stored in the IBC block vector buffer and, the current IBC block can use both IBC BV and IntraTMP BV of neighbouring blocks as BV candidate for IBC BV candidate list as shown in FIG. 8. IntraTMP block vectors are added to IBC block vector candidate list as spatial candidates.

### 2.1.8 Fusion for Template-Based Intra Mode Derivation (TIMD)

For each intra prediction mode in MPMs, as well as the wide-angle modes if the above-right and/or bottom-left reference samples are available, SATD between the prediction and reconstruction samples of the template is calculated. First two intra prediction modes with the minimum SATD are selected as the TIMD modes. These two TIMD modes are fused with the weights after applying PDPC process, and such weighted intra prediction is used to code the current CU. Position dependent intra prediction combination (PDPC) is included in the derivation of the TIMD modes.

The costs of the two selected modes are compared with a threshold, in the test the cost factor of 2 is applied as follows:

costMode2<2*costMode1.

If this condition is true, the fusion is applied, otherwise the only model is used.

Weights of the modes are computed from their SATD costs as follows:

weight1=costMode2/(costMode1+costMode2),

weight2=1−weight1.

The division operations are conducted using the same lookup table (LUT) based integerization scheme used by the CCLM.

### 2.1.9 Intra Prediction Fusion

This intra prediction method derives predicted samples as a weighted combination of multiple predictors generated from different reference lines. In this process multiple intra predictors are generated and then fused by weighted averaging. The process of deriving the predictors to be used in the fusion process is described as follows:
For angular intra prediction modes including the single mode case of TIMD and DIMD, the proposed method derives intra prediction by weighting intra predictions obtained from multiple reference lines represented as p_{fusion}=w₀pₗᵢₙₑ+w₁pₗᵢₙₑ₊₁, where pₗᵢₙₑ is the intra prediction from the default reference line and pₗᵢₙₑ₊₁ is the prediction from the line above the default reference line. The weights are set as w₀=¾ and w₁=¼.
For TIMD mode with blending, pₗᵢₙₑ is used for the first mode (w₀=1, w₁=0) and pₗᵢₙₑ₊₁ is used for the second mode (w₀=0, w₁=1).
For DIMD mode with blending, the number of predictors selected for a weighted average is increased from 3 to 6.

Intra prediction fusion method is applied to luma blocks when angular intra mode has non-integer slope (required reference samples interpolation) and the block size is greater than 16, it is used with MRL and not applied for ISP coded blocks. In the method studied in the sub-test a, PDPC is applied for the intra prediction mode using the closest to the current block reference line.

2.1.10 Combination of CIIP with TIMD and TM Merge

In CIIP mode, the prediction samples are generated by weighting an inter prediction signal predicted using CIIP-TM merge candidate and an intra prediction signal predicted using TIMD derived intra prediction mode. The method is only applied to coding blocks with an area less than or equal to 1024.

The TIMD derivation method is used to derive the intra prediction mode in CIIP. Specifically, the intra prediction mode with the smallest SATD values in the TIMD mode list is selected and mapped to one of the 67 regular intra prediction modes.

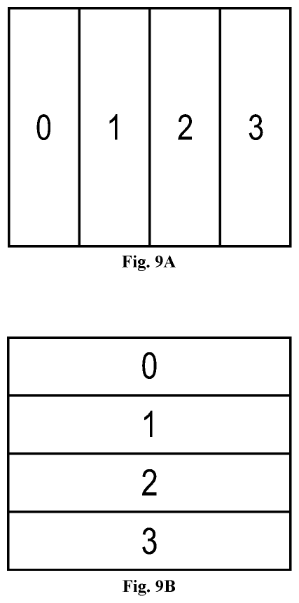

In addition, it is also proposed to modify the weights (wIntra, wInter) for the two tests if the derived intra prediction mode is an angular mode. For near-horizontal modes (2<=angular mode index <34), the current block is vertically divided as shown in FIG. 9A; for near-vertical modes (34<=angular mode index <=66), the current block is horizontally divided as shown in FIG. 9B.

The (wIntra, wInter) for different sub-blocks are shown in Table 1.

TABLE 1
The modified weights used for angular modes.

| The sub-block index | (wIntra, wInter) |
|---|---|
| 0 | (6, 2) |
| 1 | (5, 3) |
| 2 | (3, 5) |
| 3 | (2, 6) |

With CIIP-TM, a CIIP-TM merge candidate list is built for the CIIP-TM mode. The merge candidates are refined by template matching. The CIIP-TM merge candidates are also reordered by the ARMC method as regular merge candidates. The maximum number of CIIP-TM merge candidates is equal to two.

### 2.1.11 Extended Multiple Reference Line (MRL) List

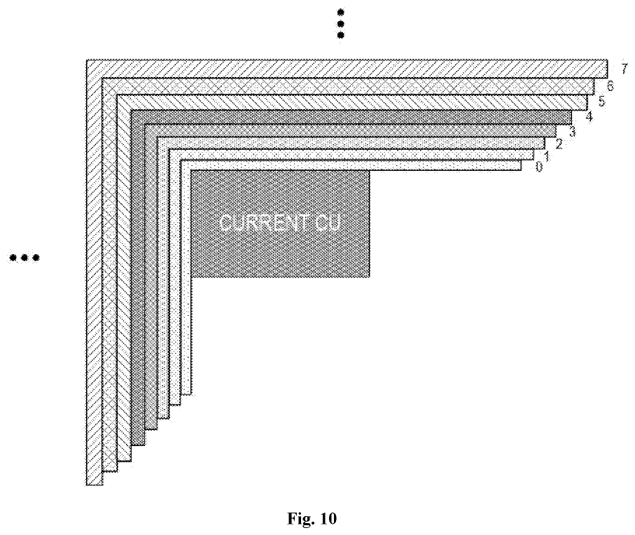

MRL list in VVC is extended to include more reference lines for intra prediction. The extended reference line list consists of line indices {1, 3, 5, 7, 12} as shown in FIG. 10. For template-based intra mode derivation (TIMD), instead of the full MRL candidate list, only the first two reference line candidates, i.e., {1, 3}, are used.

### 2.1.12 Template-Based Multiple Reference Line Intra Prediction

Template-based multiple reference line intra prediction (TMRL) mode combines reference line and prediction mode together and uses a template matching method to construct a list of candidate combinations. An index to the candidate combination list is coded to indicate which reference line and prediction mode is used in coding the current block. The regular multiple reference line (MRL) for the non-TIMD part is replaced by TMRL mode.

The TMRL mode extends reference line candidate list and the intra-prediction-mode candidate list. The extended reference line candidate list is {1, 3, 5, 7, 12}. The restriction on the top CTU row is unchanged. The size of the intra-prediction-mode candidate list is 10. The construction of the intra-prediction-mode candidate list is similar to MPM except the PLANAR mode is excluded from the intra-prediction-mode candidate list, DC mode is added after 5 neighboring PUs' modes and DIMD modes if its not included and the angular modes with delta angles from ±1 to ±4 (compared the existing angular modes in the intra-prediction-mode candidate list) are added. The precision of angular prediction is extended from 65 to 129. Additionally non-adjacent positions are added as candidates in constructing the intra candidate list. If the neighbouring or non-adjacent blocks are coded with SGPM or GPM modes, the intra modes of the blocks are replaced by the partitioning angles.

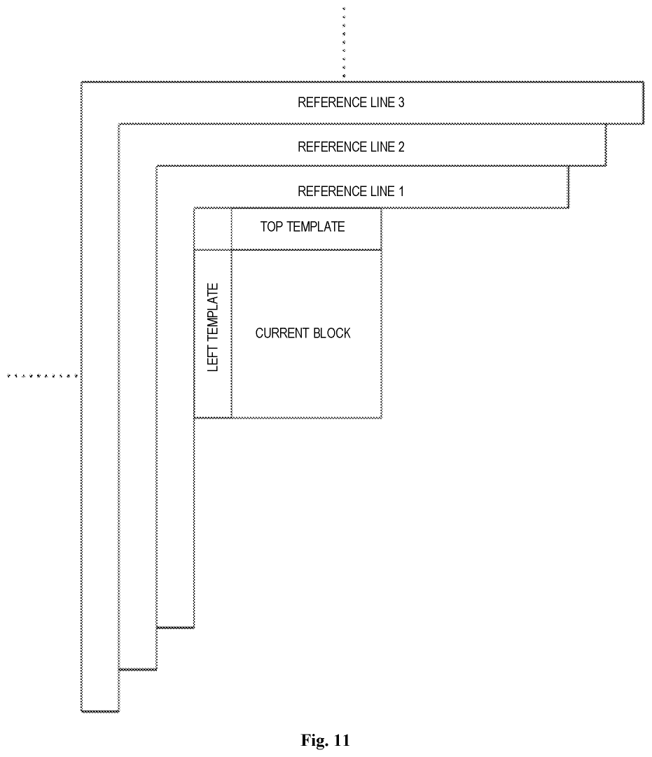

The TMRL candidate is constructed as follows. There are 5×10=50 combinations of the extended reference line and the allowed intra-prediction modes for a block. Since the extended reference line starts from reference line 1, the area covered by reference line 0 is used for template matching. The SAD costs over the template area (see FIG. 11) are calculated between the predictions (generated by 50 combinations) and the reconstructions. The 20 combinations with the least SAD cost are selected in an ascending order to form the TMRL candidate list.

For TMR signalling instead of coding the reference line and the intra mode directly, an index to the TMRL candidate list is coded to indicate which combination of reference line and prediction mode is used for coding the current block.

### 2.1.13 Convolutional Cross-Component Intra Prediction Model

In this method convolutional cross-component model (CCCM) is applied to predict chroma samples from reconstructed luma samples in a similar spirit as done by the current CCLM modes. As with CCLM, the reconstructed luma samples are down-sampled to match the lower resolution chroma grid when chroma sub-sampling is used. Similar to CCLM top, left or top and left reference samples are used as templates for model derivation.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

### 2.1.13.1 Convolutional Filter

The convolutional 7-tap filter consist of a 5-tap plus sign shape spatial component, a nonlinear term and a bias term. The input to the spatial 5-tap component of the filter consists of a center (C) luma sample which is collocated with the chroma sample to be predicted and its above/north (N), below/south (S), left/west (W) and right/east (E) neighbors as illustrated below.

The nonlinear term P is represented as power of two of the center luma sample C and scaled to the sample value range of the content:

P=(C*C+midVal)bitDepth.

That is, for 10-bit content it is calculated as:

P=(C*C+512)>>10.

The bias term B represents a scalar offset between the input and output (similarly to the offset term in CCLM) and is set to middle chroma value (512 for 10-bit content).

Output of the filter is calculated as a convolution between the filter coefficients cᵢ and the input values and clipped to the range of valid chroma samples:

predChromaVal=c₀C+c₁N+c₂S+c₃E+c₄W+c₅P+c₆B.

### 2.1.13.2 Calculation of Filter Coefficients

The filter coefficients cᵢ are calculated by minimising MSE between predicted and reconstructed chroma samples in the reference area. FIG. 13 illustrates the reference area which consists of 2 or 6 lines of chroma samples above and left of the PU. Whether to use 6 lines or 2 lines of neighbouring samples to derive the CCCM model parameters in the single model CCCM is determined by a template cost. Similarly, for the multi-model CCCM mode, the two candidates use 6 lines neighbouring luma samples or luma samples collocated to the current chroma block to derive mean values which separate samples into two groups. The cost is derived by applying the candidate CCP (either 2 or 6 lines) on a template, calculating the sum of absolute difference (SAD) between CCP predicted samples and reconstructed samples in the template.

Reference area extends one PU width to the right and one PU height below the PU boundaries. Area is adjusted to include only available samples. The extensions to the area shown in blue are needed to support the “side samples” of the plus shaped spatial filter and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

The autocorrelation matrix is calculated using the reconstructed values of luma and chroma samples. These samples are full range (e.g. between 0 and 1023 for 10-bit content) resulting in relatively large values in the autocorrelation matrix. This requires high bit depth operation during the model parameters calculation. It is proposed to remove fixed offsets from luma and chroma samples in each PU for each model. This is driving down the magnitudes of the values used in the model creation and allows reducing the precision needed for the fixed-point arithmetic. As a result, 16-bit decimal precision is proposed to be used instead of the 22-bit precision of the original CCCM implementation.

Reference sample values just outside of the top-left corner of the PU are used as the offsets (offsetLuma, offsetCb and offsetCr) for simplicity. The samples values used in both model creation and final prediction (i.e., luma and chroma in the reference area, and luma in the current PU) are reduced by these fixed values, as follows:

C′=C−offsetLuma,

N′=N−offsetLuma,

S′=S−offsetLuma,

E′=E−offsetLuma,

W′=W−offsetLuma,

P′=nonLinear(C′),

B=midValue=1<<(bitDepth−1),

and the chroma value is predicted using the following equation, where offsetChroma is equal to offsetCr and offsetCb for Cr and Cb components, respectively:

predChromaVal=c₀C′+c₁N′+c₂S′+c₃E′+c₄W′+c₅P′+c₆B+offsetChroma.

In order to avoid any additional sample level operations, the luma offset is removed during the luma reference sample interpolation. This can be done, for example, by substituting the rounding term used in the luma reference sample interpolation with an updated offset including both the rounding term and the offsetLuma. The chroma offset can be removed by deducting the chroma offset directly from the reference chroma samples. As an alternative way, impact of the chroma offset can be removed from the cross-component vector giving identical result. In order to add the chroma offset back to the output of the convolutional prediction operation the chroma offset is added to the bias term of the convolutional model.

The process of CCCM model parameter calculation requires division operations. Division operations are not always considered implementation friendly. The division operation are replaced with multiplication (with a scale factor) and shift operation, where scale factor and number of shifts are calculated based on denominator similar to the method used in calculation of CCLM parameters.

### 2.1.13.3 Gradient Linear Model

For YUV 4:2:0 color format, a gradient linear model (GLM) method can be used to predict the chroma samples from luma sample gradients. Two modes are supported: a two-parameter GLM mode and a three-parameter GLM mode.

Compared with the CCLM, instead of down-sampled luma values, the two-parameter GLM utilizes luma sample gradients to derive the linear model. Specifically, when the two-parameter GLM is applied, the input to the CCLM process, i.e., the down-sampled luma samples L, are replaced by luma sample gradients G. The other parts of the CCLM (e.g., parameter derivation, prediction sample linear transform) are kept unchanged.

C=α·G+β.

In the three-parameter GLM, a chroma sample can be predicted based on both the luma sample gradients and down-sampled luma values with different parameters. The model parameters of the three-parameter GLM are derived from 6 rows and columns adjacent samples by the LDL decomposition based MSE minimization method as used in the CCCM.

C=α₀·G+α₁·L+α₂/β.

For signaling, when the CCLM mode is enabled to the current CU, one flag is signaled to indicate whether GLM is enabled for both Cb and Cr components; if the GLM is enabled, another flag is signaled to indicate which of the two GLM modes is selected and one syntax element is further signaled to select one of 4 gradient filters for the gradient calculation.
Four gradient filters are enabled for the GLM, as illustrated in FIG. 14.
   2.1.13.4 CCCM signalling

Usage of the mode is signalled with a CABAC coded PU level flag. One new CABAC context was included to support this. When it comes to signalling, CCCM is considered a sub-mode of CCLM. That is, the CCCM flag is only signalled if intra prediction mode is LM_CHROMA.

### 2.1.13.5 CCCM Using Non-Downsampled Luma Samples

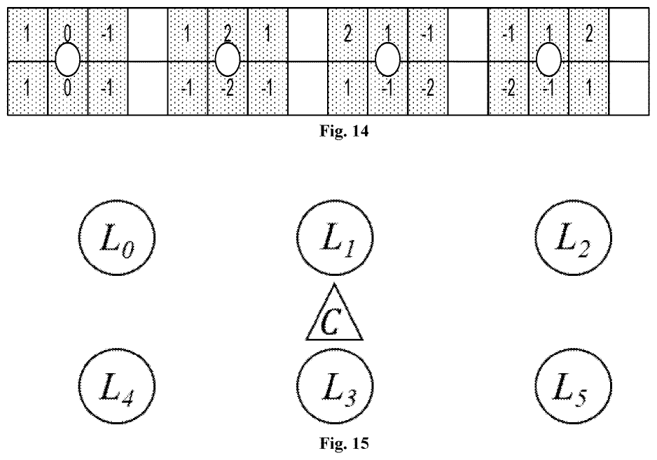

CCCM mode with 3×2 filter using non-downsampled luma samples is used, which consists of 6-tap spatial terms, four nonlinear terms and a bias term. The 6-tap spatial terms correspond to 6 neighboring luma samples (i.e., L₀, L₁, . . . , L₅) around the chroma sample (i.e., C) to be predicted, the four non-linear terms are derived from the samples L₀, L₁, L₂, and L₃ as shown in FIG. 15.

$$C = {\sum }_{i = 0}^{5} {α}_{i} \cdot ( {L}_{i} - offsetLuma ) + {\sum }_{i = 6}^{9} {α}_{i} \cdot ( ( {( {L}_{i - 4} - offsetLuma )}^{2} + β ) >> bitDepth + {α}_{10} \cdot β + offsetChroma$$

where αᵢ is the coefficient, β is the offset. Same to the existing CCCM design, up to 6 lines/columns of chroma samples above and left to the current CU are applied to derive the filter coefficients. The filter coefficients are derived based on the same LDL decomposition method used in CCCM. The proposed method is signaled as an additional CCCM model besides the existing one, when the CCCM is selected, one single flag is signaled and used for both two chroma components to indicate whether the default CCCM model or the proposed CCCM model is applied. Additionally, SPS signaling is introduced to indicate whether the CCCM using non-downsampled luma samples is enabled.

### 2.1.13.6 Block-Vector Guided CCCM (BVG-CCCM)

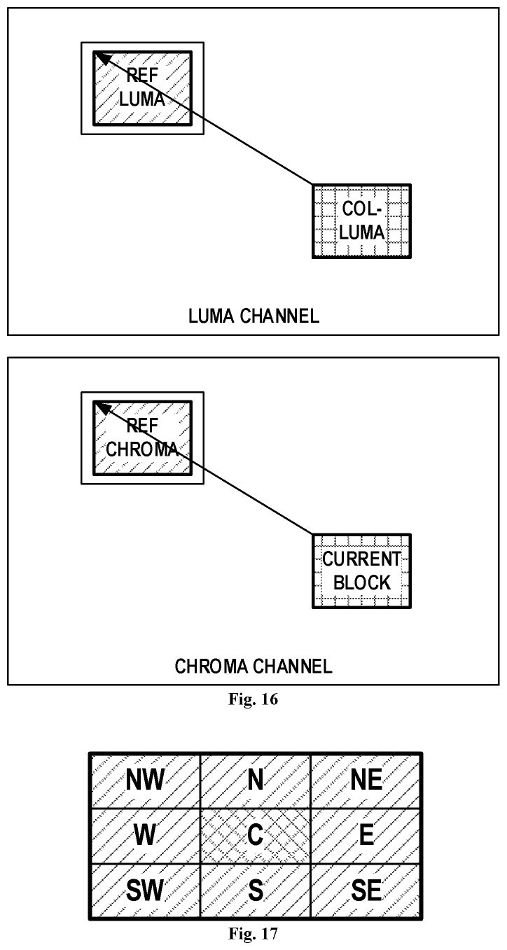

When the co-located luma prediction is coded with IBC or IntraTMP in Intra slices, the BVG-CCCM mode can be used. In this mode, the block vectors of the co-located luma blocks, coded in IBC or intraTMP modes, are used to determine the reference area for calculating the CCCM parameters. The prediction is performed using uses the calculated model parameters and co-located luma samples. FIG. 16 illustrates the reference area in BVG-CCCM method.

The BVG-CCCM mode uses an 11-tap filter for cross-component prediction as below:

predChromaVal=c₀C+c₁N+c₂S+c₃E+c₄W+c₅P(C)+c₆P(N)+c₇P(S)+c₈P(W)+c₉P(E)+c₁₀B.

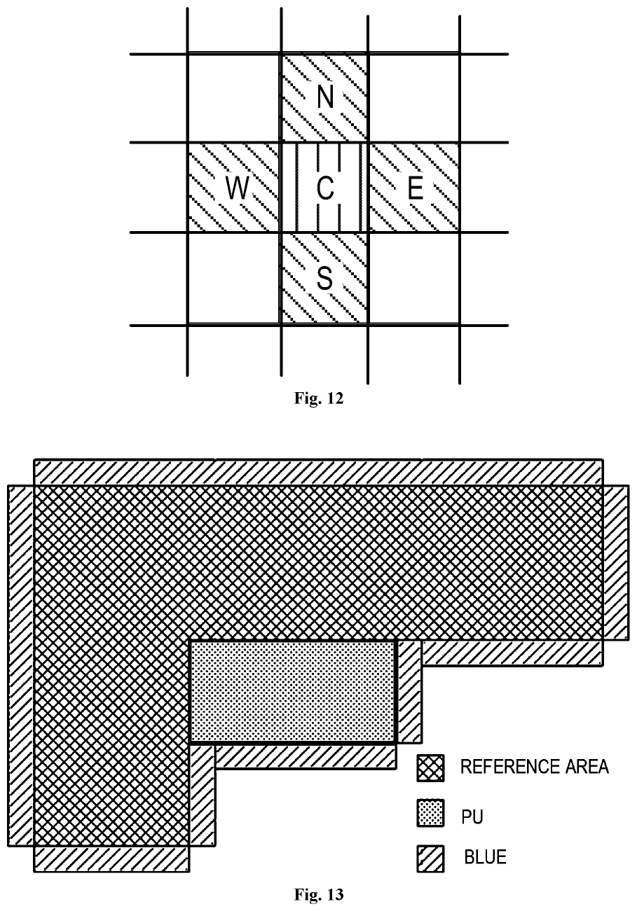

The input to the spatial 5-tap component of the filter consists of a center (C) luma sample which is collocated with the chroma sample to be predicted and its above/north (N), below/south (S), left/west (W) and right/east (E) neighbors as illustrated in FIG. 12.

The nonlinear term P is represented as power of two of the corresponding luma sample and B is the bias term. Similar to Direct Block Vector (DBV Sec. 2.1.13.6), five locations, in the collocated luma block area are scanned and the associated block vectors are then used for determining the reference area for parameter calculation in BVG-CCCM method.

### 2.1.13.7 Gradient and Location Based Convolutional Cross-Component Model (GL-CCCM)

This method maps luma values into chroma values using a filter with inputs consisting of one spatial luma sample, two gradient values, two location information, a nonlinear term, and a bias term. The GL-CCCM method uses gradient and location information instead of the 4 spatial neighbor samples used in the CCCM filter. The GL-CCCM filter used for the prediction is:

predChromaVal=c₀C+c₁G_{y}+c₂Gₓ+c₃Y+c₄X+c₅P+c₆B.

Where G_{y} and Gₓ are the vertical and horizontal gradients, respectively, and are calculated as FIG. 17:

G_{y}=(2N+NW+NE)−(2S+SW+SE),

Gₓ=(2W+NW+SW)−(2E+NE+SE).

Moreover, the Y and X are the spatial coordinates of the center luma sample.

The rest of the parameters are the same as CCCM tool. The reference area for the parameter calculation is the same as CCCM method.

The usage of the mode is signalled with a CABAC coded PU level flag. When it comes to signalling, GL-CCCM is considered a sub-mode of CCCM. That is, the GL-CCCM flag is only signalled if original CCCM flag is true.

Similar to the CCCM, GL-CCCM tool has 6 modes for calculating the parameters:
Single-model GL-CCCM from above and left templates,
Single-model GL-CCCM from above template,
Single-model GL-CCCM from left template,
Multi-model GL-CCCM from above and left templates,
Multi-model GL-CCCM from above template,
Multi-model GL-CCCM from left template.

The encoder performs SATD search for the 6 GL-CCCM modes along with the existing CCCM modes to find the best candidates for full RD tests.

2.1.13.8 CCCM with Multiple Downsampling Filters

Multiple downsampling filters are applied to a group of reconstructed luma samples in a CCCM. The linear combination of these downsampled reconstructed samples is multiplied by derived filter coefficients to form the final chroma predictor. The horizontal or vertical location of the center luma sample are also considered in the tested model. The cross-component models shown below are tested as additional CCCM modes with a mode index signalled in the bitstream:

predChroma=c0*H(C)+c1*G1(C)+c2*G2(C)+c3*G3(C)+c4*P(H(C))+c5*P(G1(C))+c6*P(G2(C))+c7*X+c8*Y+c9*B. (1) Model 1:

predChroma=c0*H(C)+c1*H(W)+c2*H(E)+c3*G1(C)+c4*G1(W)+c5*G1(E)+c6*P(H(C))+c7*P(H(W))+c8*P(H(E))+c9*X+c10*B. (2) Model 2:

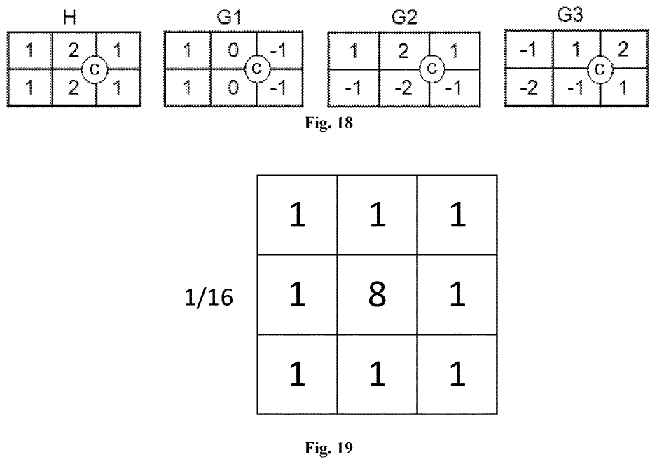

predChroma=c0*H(C)+c1*H(NE)+c2*H(SW)+c3*G3(C)+c4*G3(NE)+c5*G3(SW)+c6*P(H(C))+c7*P(H(NE))+c8*P(H(SW))+c9*Y+c10*B. (3) Model 3:

where H(⋅), G1(⋅), G2(⋅), G3(⋅) are various downsampling filters as indicated in FIG. 18, C denotes the current chroma sample position, and N, S, W, E, NE, SW are the positions around C, cᵢ are filter coefficients, P and B are nonlinear term and bias term, and X and Y are the horizontal and vertical locations of the center luma sample with respect to the top-left coordinates of the block.

### 2.1.14 Local-Boosting Cross-Component Prediction (LB-CCP)

Prediction samples of MM-CCLM/MM-CCCM can be filtered with neighbouring samples. As shown in FIG. 19, a 3×3 low-pass filter is applied to filter prediction samples generated by MM-CCLM/MM-CCCM. For a sample at a top/left boundary, the filtering window may involve neighbouring reconstructed samples. For inner samples, the filtering window only involves prediction samples, which may be padded. A flag is signaled to indicate whether filtering is applied or not for a block coded with MM-CCLM/MM-CCCM.

### 2.1.15 Cross-Component Prediction (CCP) Merge (a.k.a., Non-Local CCP) Mode

For chroma coding, a flag is signalled to indicate whether CCP mode (including the CCLM, CCCM, GLM and their variants) or non-CCP mode (conventional chroma intra prediction mode, fusion of chroma intra prediction mode) is used. If the CCP mode is selected, one more flag is signalled to indicate how to derive the CCP type and parameters, i.e., either from a CCP merge list or signalled/derived on-the-fly. a CCP merge candidate list is constructed from the spatial adjacent, temporal, spatial non-adjacent, history-based m or shifted temporal candidates. After including these candidates, default models are further included to fill the remaining empty positions in the merge list. In order to remove redundant CCP models in the list, pruning operation is applied. After constructing the list, the CCP models in the list are reordered depending on the SAD costs, which are obtained using the neighbouring template of the current block. More details are described below.

### Spatial Adjacent and Non-Adjacent Candidates

The positions and inclusion order of the spatial adjacent and non-adjacent candidates are the same as those defined in ECM for regular inter merge prediction candidates.

### Temporal and Shifted Temporal Candidates

Temporal candidates are selected from the collocated picture. The position and inclusion order of the temporal candidates are the same as those defined in ECM for regular inter merge prediction candidates. The shifted temporal candidates are also selected from the collocated picture. The position of temporal candidates is shifted by a selected motion vector which is derived from motion vectors of neighboring blocks.

### History-Based Candidates

A history-based table is maintained to include the recently used CCP models, and the table is reset at the beginning of each CTU row. If the current list is not full after including spatial adjacent and non-adjacent candidates, the CCP models in the history-based table are added into the list.

### Default Candidates

CCLM candidates with default scaling parameters are considered, only when the list is not full after including the spatial adjacent, spatial non-adjacent, or history-based candidates. If the current list has no candidates with the single model CCLM mode, the default scaling parameters are {0, ⅛, −⅛, 2/8, − 2/8, ⅜, −⅜, 4/8, − 4/8, ⅝, −⅝, 6/8}. Otherwise, the default scaling parameters are {0, the scaling parameter of the first CCLM candidate+{⅛, −⅛, 2/8, − 2/8, ⅜, −⅜, 4/8, − 4/8, ⅝, −⅝, 6/8}}.

A flag is signaled to indicate whether the CCP merge mode is applied or not. If CCP merge mode is applied, an index is signaled to indicate which candidate model is used by the current block. In addition, CCP merge mode is not allowed for the current chroma coding block when the current CU is coded by intra sub-partitions (ISP) with single tree, or the current chroma coding block size is less than or equal to 16.

### 2.1.16 Spatial Geometric Partitioning Mode (SGPM)

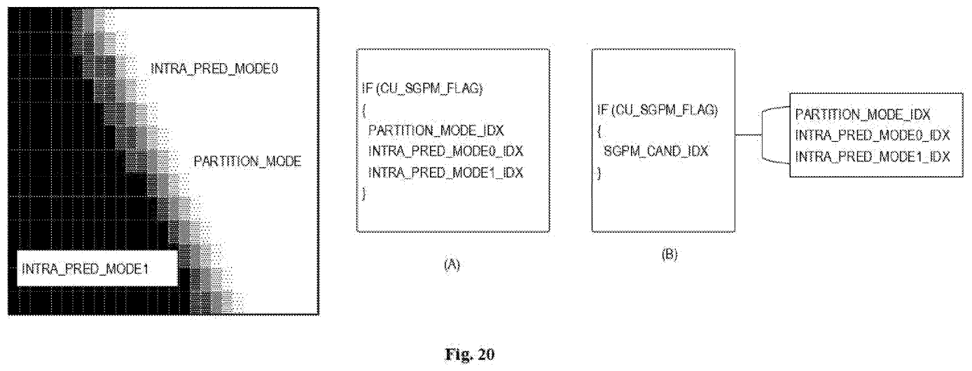

SGPM is an intra mode that resembles the inter coding tool of GPM, where the two prediction parts are generated from intra predicted process. In this mode, a candidate list is built with each entry containing one partition split and two intra prediction modes as shown in FIG. 20. 26 partition modes and 3 of intra prediction modes are used to form the combinations, the length of the candidate list is set equal to 16. The selected candidate index is signalled.

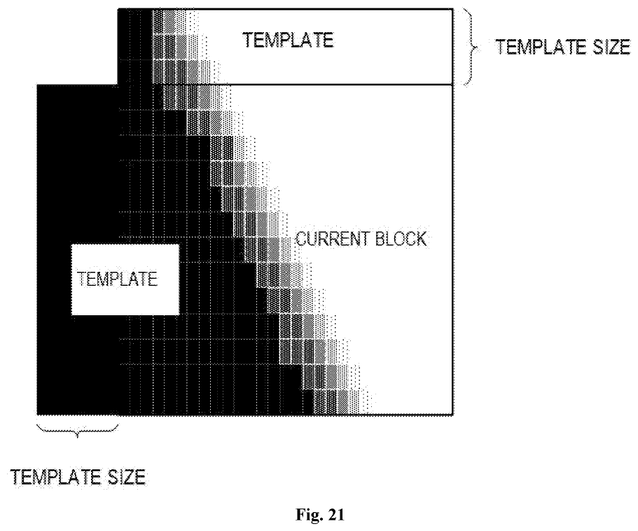

The list is reordered using template (see FIG. 21) where SAD between the prediction and reconstruction of the template is used for ordering. The template size is fixed to 1.

For each partition mode, an IPM list is derived for each part using the same intra-inter GPM list derivation. The IPM list size is set to 3. In the list, TIMD derived mode is replaced by 2 derived modes with horizontal and vertical orientations.

The SGPM mode is applied with a restricted blocks size: 4<=width<=64, 4<=height<=64, width<height*8, height<width*8, width*height>=32.

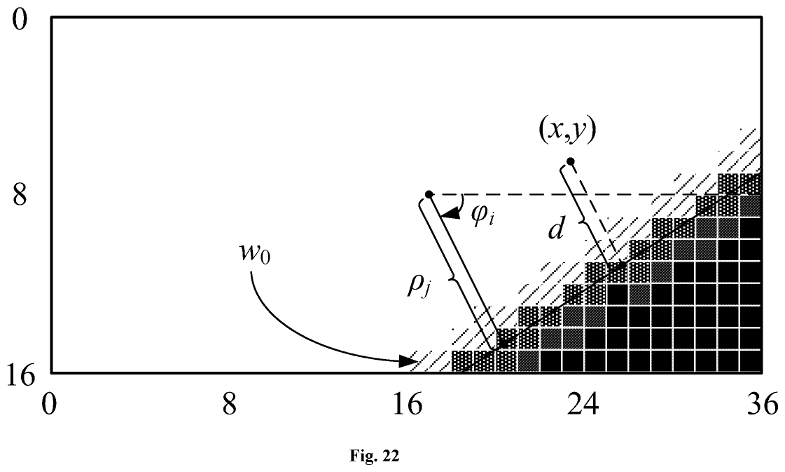

A PPS flag is coded to indicate whether no blending of two intra predictions is allowed. When this PPS flag is set to false, the following adaptive blending is also used for spatial GPM, where blending depth t shown in FIG. 22 is derived as follows:
If min(width, height)==4, ½ τ is selected,
else if min(width, height)==8, τ is selected,
else if min(width, height)==16, 2 τ is selected,
else if min(width, height)==32, 4 τ is selected,
else, 8 τ is selected.

Otherwise (the PPS flag is set to true), ¼ τ is always used for spatial GPM coded blocks to make sure no blending is used when SGPM block has partition angle completely horizontal or vertical, and much narrower blending width is used when SGPM block has other partition angles. It is noted that the flag is set to true in current Common Test Conditions (CTC) for the screen content videos.

### 2.1.17 Directional Planar Mode

Two additional planar modes where only the horizontal interpolation or only the vertical interpolation are used to obtain the predicted samples.

For planar horizontal mode, only the horizontal linear interpolation is performed based on the left reference sample and the top-right reference sample to predict the current sample as:

pred(x,y)=((W−1−x)*rec(−1,y)+(x+1)*rec(W,−1)+(W>>1))log₂(W).

For planar vertical mode, only the vertical linear interpolation is performed based on the above reference sample and the bottom-left reference sample to predict the current sample as:

pred(x,y)=((H−1−y)*rec(x,−1)+(y+1)*rec(−1,H)+(H>>1))log₂(H).

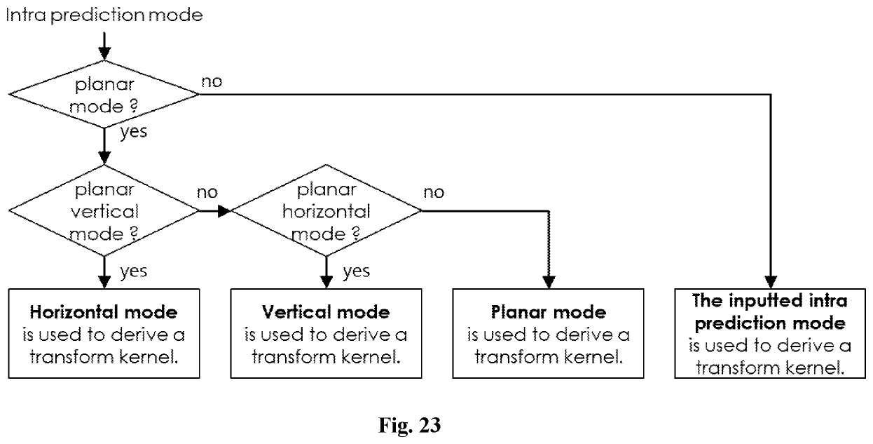

The transform kernel selection for planar horizontal and planar vertical mode is shown in FIG. 23. If an intra prediction mode of a current block is the planar vertical mode, the horizontal intra prediction mode is used to derive a transform kernel in MTS set and LFNST set. Also, if an intra prediction mode of a current block is the planar horizontal mode, the vertical intra prediction mode is used to derive a transform kernel in MTS set and LFNST set.

### 2.1.18 Direct Block Vector for Chroma Block

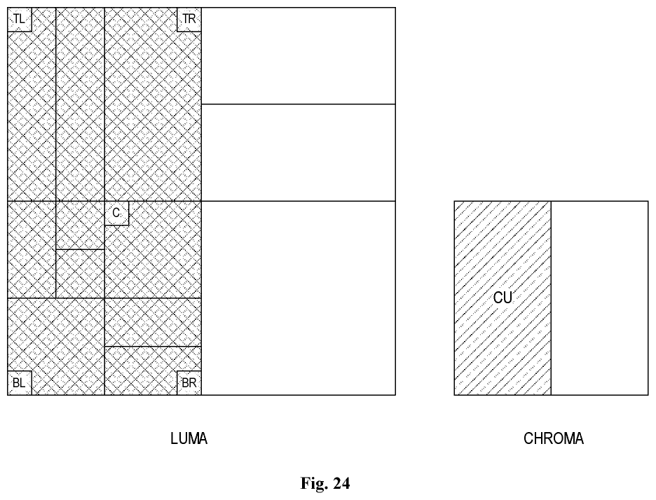

The direct block vector is used for chroma block in dual tree slices. When chroma dual tree is activated, a flag is signaled to indicate whether a chroma block is coded using IBC mode. If one of the luma blocks in five locations shown in FIG. 24 is coded with IBC or intraTMP mode, its block vector is scaled and is used as block vector for the chroma block. Template matching is used to perform block vector scaling.

### 2.1.18.1 Prediction of Current Block

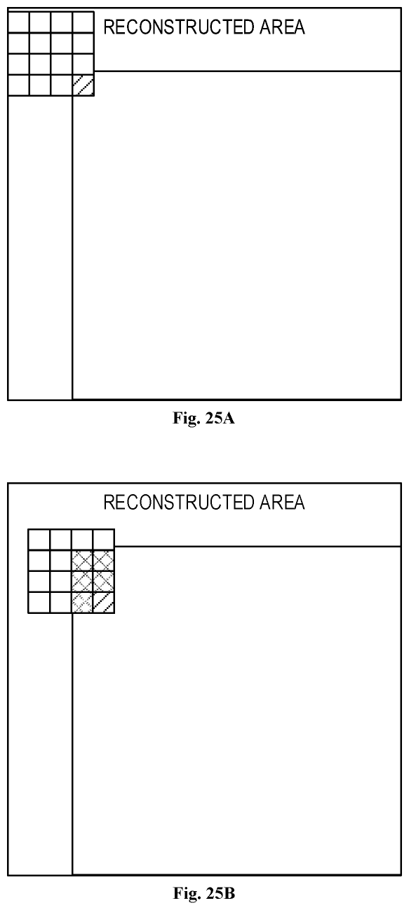

The EIP mode makes predictions for the current block position by position, as shown in FIG. 25A to FIG. 25C.

In FIG. 25A, all inputs to EIP are reconstructed samples. In FIG. 25B, partial inputs are reconstructed samples, partial inputs are predicted samples. In FIG. 25C, all inputs to EIP area predicted samples.

For the position located at top-left of the current block, the inputs to the EIP filter are reconstructed samples.

For the positions located along the boundaries of the current block, partial inputs to the EIP filter are reference samples, and partial inputs to the EIP filter are previously predicted samples.

For other positions in the current block, the inputs to the EIP filter are previously predicted samples.

To reduce the prediction error, the searched min and max values are applied to restrict the output range of each predicted value,

$${pred}_{( x , y )} = clip ( min , max , ( {\sum }_{i = 0}^{n} ( {c}_{i} \times ( {t}_{( x - xoffset , y - yoffset )} - mean ) ) ) + mean )$$

pred_{(x,y)} is the predicted value at (x,y) in the current block,
min, max are searched min and max values from the thirteen reconstructed columns and rows,
cᵢ is the i^{th} coefficient of the derived EIP filter,
t_{(x-xoffset,y-yoffset)} is reconstructed or predicted value used for the current position's prediction, mean is a value calculated by the DC prediction mode.

### 2.1.19 An Extrapolation Filter-Based Intra Prediction Mode (EFI Mode)

The proposed extrapolation filter-based intra prediction is processed in two steps. First, the extrapolation filter coefficients are obtained from the neighboring reconstructed pixels of the current block with a pre-determined template. Second, the extrapolation generates a predicted value position by position from top-left to bottom-right within the current block.

### 2.1.19.1 Searching Mean, Min, and Max Value

Similar to CCCM mode, a mean value should be removed when feeding the inputs to the EIP filter. The value of the DC mode for the current block is used as a mean value for EIP prediction. The min and max value are searched from reconstructed pixels in the reconstructed area with thirteen columns and thirteen rows.

### 2.1.19.2 Calculation of Filter Coefficients

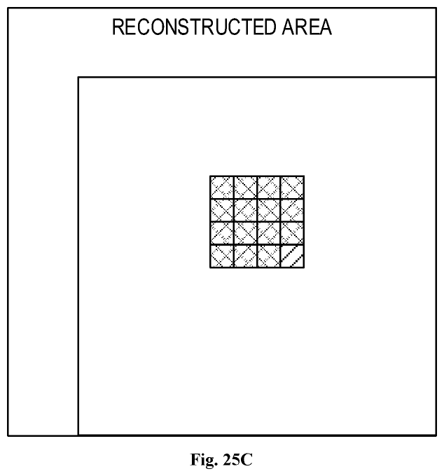

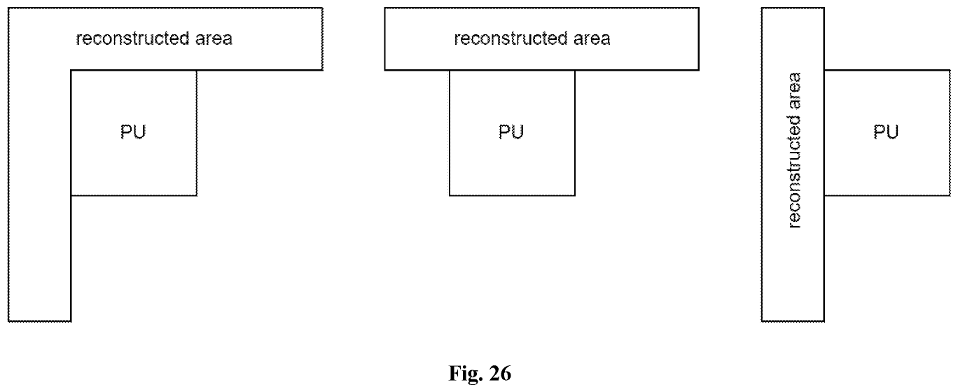

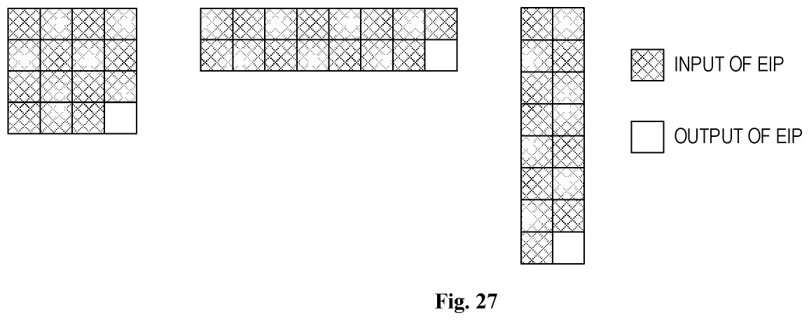

Three types of reconstructed areas and three filter shapes are proposed, as shown in FIG. 26. When the current block uses the proposed EIP mode for prediction, the decoder decodes the relevant syntax elements to determine the selected type of reconstructed area and filter shape for the current block.

The selected filter slides in the selected reconstructed area with a one-pixel step to collect input samples and output samples of EIP. The auto-correlation matrix and cross-correlation vector are constructed while removing the mean value from input samples and output samples. Then, the EIP coefficients are obtained by the same method in CCCM.

### 2.1.19.3 Prediction of Current Block

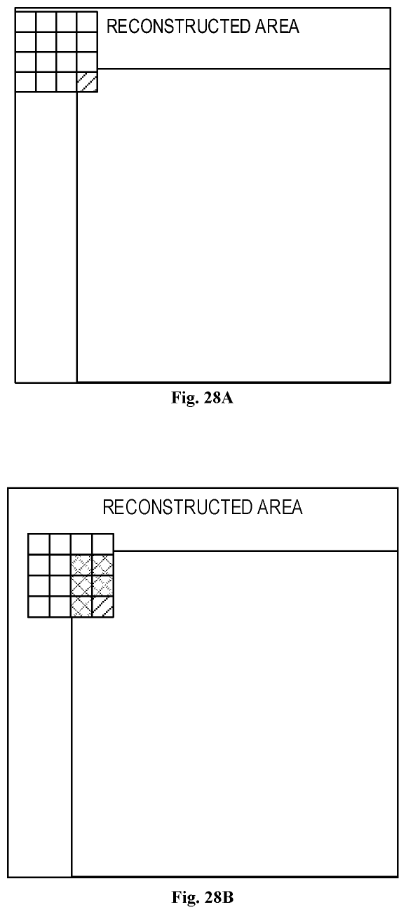

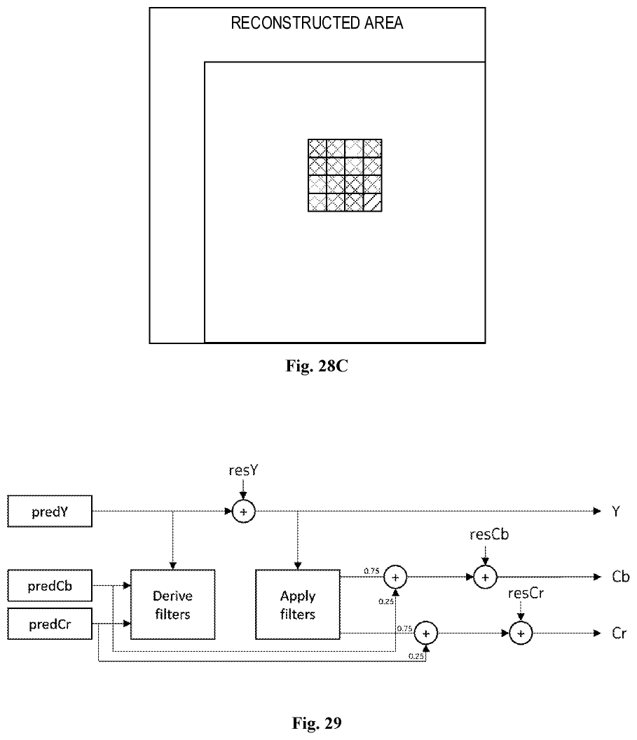

The EIP mode makes predictions for the current block position by position, as shown FIG. 28A to FIG. 28C. In FIG. 28A, all inputs to EIP are reconstructed samples. In FIG. 28B, partial inputs are reconstructed samples, partial inputs are predicted samples. In FIG. 28C, all inputs to EIP area predicted samples.

For the position located at top-left of the current block, the inputs to the EIP filter are reconstructed samples. For the positions located along the boundaries of the current block, partial inputs to the EIP filter are reference samples, and partial inputs to the EIP filter are previously predicted samples.

For other positions in the current block, the inputs to the EIP filter are previously predicted samples.

To reduce the prediction error, the searched min and max values are applied to restrict the output range of each predicted value,

$${pred}_{( x , y )} = clip ( min , max , ( {\sum }_{i = 0}^{n} ( {c}_{i} \times ( {t}_{( x - xoffset , y - yoffset )} - mean ) ) ) + mean )$$

pred_{(x,y)} is the predicted value at (x,y) in the current block,
min, max are searched min and max values from the thirteen reconstructed columns and rows,
cᵢ is the i^{th} coefficient of the derived EIP filter,
t_{(x-xoffset,y-yoffset)} is reconstructed or predicted value used for the current position's prediction, mean is a value calculated by the DC prediction mode.

### 2.2 InterCCCM

InterCCCM applies the CCCM method for predicting chroma samples from reconstructed luma samples when the CU uses inter prediction or intra block copy (IBC). FIG. 29 illustrates the decoder side of the method. The cross-component filters are derived using the prediction blocks of luma and chroma. The derived filters are applied to the reconstructed luma block and blended with the prediction blocks of chroma to produce the final chroma prediction blocks. In the blending process the filtered reconstructed luma blocks use blending weight of 0.75 and chroma prediction blocks use blending weight of 0.25.

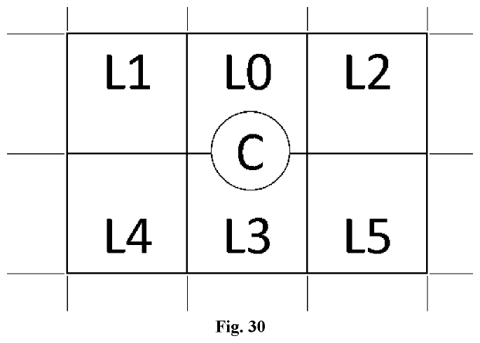

The 8-tap filter consist of 6 spatial luma samples, a nonlinear term, and a bias term. The spatial luma samples (L0, . . . , L5) are obtained from the luma grid selecting the 6 luma samples closest to the chroma position C without down sampling as shown in FIG. 30. The predicted chroma value is obtained as,

predChromaVal=c₀L0+c₁L1+c₂L2+c₃L3+c₄L4+c₅L5+c₆nonlinear((L0+L3+1)>>1)+c₇B,
where nonlinear is CCCM's nonlinear operator and B is bias. The filter coefficients are derived using ECM's division-free Gaussian elimination method and the necessary offsets are applied to samples prior to filter derivation. The offsets for division-free Gaussian elimination method are obtained using a four-point average of the luma and chroma prediction blocks, where the four points correspond to the top-left, top-right, bottom-left and bottom-right corners of the blocks. For filter coefficient derivation at most 256 chroma samples are used. Usage of the mode is signalled with a CABAC coded TU level flag. One new CABAC context was included to support this. The InterCCCM flag is only signalled if the TU's luma Cbf is non-zero and the CU's predMode is either MODE_INTER or MODE_IBC.

The encoder performs an RD decision in the transform selection loop for the chroma components when luma Cbf is non-zero and the CU's predMode is either MODE_INTER or MODE_IBC.

### 2.3 Block Vector Guided CCCM

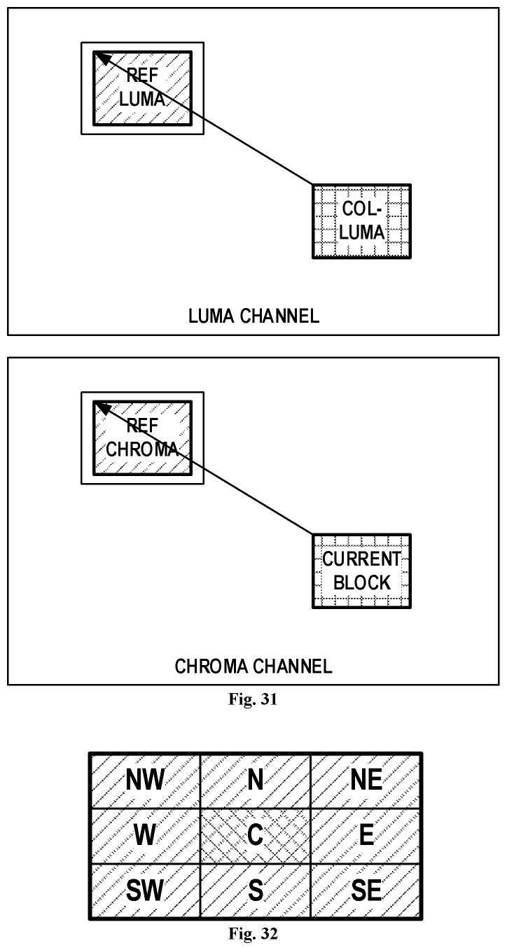

The block vector guided CCCM (BVG-CCCM) method uses block vectors of the co-located luma blocks, coded in IBC or intraTMP modes, to determine the reference area for calculating the CCCM parameters. Then the reference area in luma and corresponding area in chroma channel is used to calculate the CCCM parameters. The prediction uses the calculated model parameters and co-located luma samples to do the CCCM prediction. FIG. 31 illustrates the reference area in BVG-CCCM method.

The mode is enabled only in intra slices. Moreover, an SPS-level flag is introduced for enabling or disabling the mode.

The BVG-CCCM mode uses an 11-tap filter for cross-component prediction as below:

predChromaVal=c₀C+c₁N+c₂S+c₃E+c₄W+c₅P(C)+c₆P(N)+c₇P(S)+c₈P(W)+c₉P(E)+c₁₀B.

The input to the spatial 5-tap component of the filter consists of a center (C) luma sample which is collocated with the chroma sample to be predicted and its above/north (N), below/south (S), left/west (W) and right/east (E) neighbors as illustrated in FIG. 32.

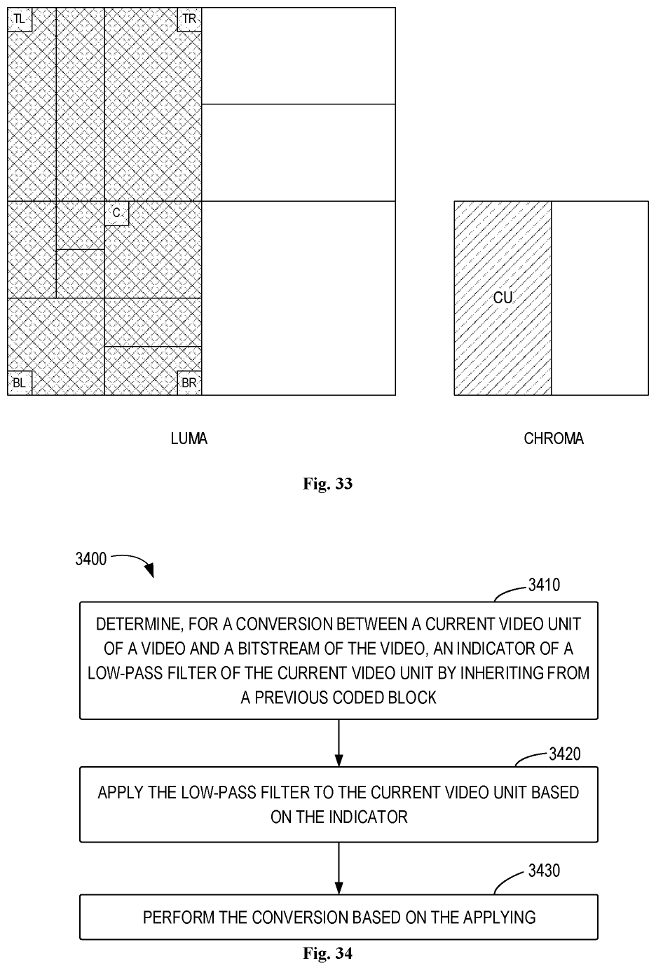

The nonlinear term P is represented as power of two of the corresponding luma sample and B is the bias term. Similar to Direct Block Vector (DBV) mode in ECM-9.0, five locations, as shown in FIG. 33, in collocated luma block area are scanned and the associated block vectors are then used for determining the reference area for parameter calculation in BVG-CCCM method.

The mode can use block vector(s) of both IBC and intraTMP coded blocks from co-located luma area.

### 2.3.1 Bitstream Signalling

Usage of the mode is signalled with a CABAC coded PU level flag. The BVG-CCCM flag is signalled if co-located block is coded in IBC or intraTMP modes and the cross-component index is LM_CHROMA_IDX or MMLM_CHROMA_IDX.

### 2.3.2 Encoder Operation

The encoder performs two additional RD for the BVG-CCCM for single-model and multi-model CCCM variants.

### 3 PROBLEMS

Below issues exist in the current ECM and can be improved.
1) In the current ECM, a low-pass filter (i.e., LBCCP) is applied to a multi-model model based intra CCCM/CCLM prediction block. However, the LBCCP can be applied to applied to more CCP predictions. Moreover, how to handle LBCCP in case of template-based reordering can be further designed.

### 4 DETAILED SOLUTIONS

The detailed embodiments below should be considered as examples to explain general concepts. These embodiments should not be interpreted in a narrow way. Furthermore, these embodiments can be combined in any manner.

The terms “video unit” or “coding unit” or “block” may represent a picture, a slice, a tile, a coding tree block (CTB), a coding tree unit (CTU), a coding block (CB), a CU, a PU, a TU, a PB, or a TB.

The term “prediction unit” may represent a prediction block, or a prediction sample.

The term “CCP” may refer to any cross-component prediction method such as any kind of LM/intraCCLM/interCCCM/MMLM/CCCM/GLM/GL-CCCM/intraCCPmerge/interCCPmerge. It could be used for an intra block, inter block, or IBC block. It could be a type of CCP based fusion mode.

The term “linear/non-linear filter” may refer to a filter/model wherein its coefficients are derived based on a linear regression model or a non-linear model. It could be used for cross-component prediction such as CCP, or same-component prediction such as EFI, filtered IBC, filtered intraTMP, etc.

The term “low pass filter” may refer to LBCCP, or any other low pass filters.

It is noted that the terminologies mentioned below are not limited to the specific ones defined in existing standards. Any variance of the coding tool is also applicable.
1) The indicator of a low pass filter (e.g., LBCCP flag) of the current coding unit may be inherited from a previous coded block.
a) In one example, whether to apply a low pass filter to the current block may be inherited from a previous coded block.
b) For example, the current coding unit may be:
   i) an interCCP mode (e.g., interCCCM, interCCP, interCCPmerge, interCCPfusion, etc).
   ii) a non-CCP inter mode (e.g., inter merge, inter CIIP, inter GPM, GPM inter-intra, inter AMVP, inter amvp-merge, inter affine, etc.).
   iii) an intraCCP mode (e.g., intraCCCM, CCCM-MDF, GL-CCCM, NS-CCCM, GLM, CCLM, intraCCPmerge, intraCCPfusion, etc).
   iv) a non-CCP intra mode (e.g., filtered intra mode, filtered intraTMP, EFI filtered intra mode, BIF filtered intra mode, Hadamard filtered intra mode, regular intra mode, etc).
   v) a filtered IBC mode.
   vi) a regular IBC mode without linear/non-linear filtering.
   vii) decoded derived CCP mode.
   viii) encoder selected CCP mode.
   ix) multi-model CCP mode.
   x) single model CCP mode.
c) For example, the previous coded block may be:
   i) a block (e.g., a spatial adjacent neighbor, a spatial non-adjacent neighbor, or a candidate from a history-based table, etc) in the current picture.
   ii) a block (e.g., a temporal neighbor, etc) from a picture in the decoded picture buffer.
2) A low pass filter (e.g., LBCCP) may be applied to filter a fusion mode coded current block.
a) For example, a prediction of the current block may be firstly fused with another prediction, then processed by the low pass filter to form the final prediction for the current block.
b) For example, a prediction of the current block may be firstly processed by the low pass filter, and then fused with another prediction to form the final prediction for the current block.
c) For example, the current block may be intra, inter, or IBC coded.
3) The indicator of a low pass filter (e.g., LBCCP flag) of the current coding unit may be stored in a temporal buffer.
a) Furthermore, alternatively, the indicator of a low pass filter (e.g., LBCCP flag) of the current coding unit may be stored in a history buffer.
b) In one example, the information of the low pass filter in the stored temporal buffer may be used for a future coding block in a future picture.
   i) For example, the future picture is coded after the current picture.
c) In one example, the information of the low pass filter in the stored history buffer may be used for a future coding block in the current picture.
d) In one example, the current coding unit and/or the future coding block may be:
   i) an intra coded block (e.g., intraCCCM, CCCM-MDF, GL-CCCM, NS-CCCM, GLM, CCLM, intraCCPmerge, filtered intra mode, filtered intraTMP, EFI filtered intra mode, BIF filtered intra mode, Hadamard filtered intra mode, regular intra mode, etc).
   ii) an inter coded block (e.g., interCCCM, interCCP, interCCPmerge, filtered inter, inter merge, inter CIIP, inter GPM, GPM inter-intra, inter AMVP, inter amvp-merge, inter affine, etc).
   iii) an IBC coded block (e.g., filtered IBC mode, regular IBC mode without linear/non-linear filtering, etc).
   iv) decoded derived CCP mode.
   v) encoder selected CCP mode.
   vi) multi-model CCP mode.
   vii) single model CCP mode.
4) When a redundancy check (or pruning process) is performed between motion/CCP candidates with and without low pass filter, the indicator of the low pass filter associated with the motion/CCP candidates may be considered.
a) For example, if the values of the indicators of the low pass filter of the two candidates are different, the two candidates may be treated as different candidates (even if the motion/CCP information except the low pass filter aspect of the two candidates may be similar/same).
   i) For example, if the motion/CCP information except the low pass filter aspect of the two candidates are similar/same, and the values of the indicators of the low pass filter of the two candidates are also same, the two candidates may be treated as redundant.
b) Alternatively, the motion/CCP candidates may be treated as redundant, regardless of the value of the indicator of the low pass filter associated with the motion/CCP candidates.
   i) For example, if the motion/CCP information except the low pass filter aspect of the two candidates are similar/same, but the values of the indicators of the low pass filter of the two candidates are different, the two candidates may be treated as redundant.
c) For example, the claimed bullets may be applied to:
   i) an intra coded block (e.g., intraCCCM, CCCM-MDF, GL-CCCM, NS-CCCM, GLM, CCLM, intraCCPmerge, filtered intra mode, filtered intraTMP, EFI filtered intra mode, BIF filtered intra mode, Hadamard filtered intra mode, regular intra mode, etc).
   ii) an inter coded block (e.g., interCCCM, interCCP, interCCPmerge, filtered inter, inter merge, inter CIIP, inter GPM, GPM inter-intra, inter AMVP, inter amvp-merge, inter affine, etc).
   iii) an IBC coded block (e.g., filtered IBC mode, regular IBC mode without linear/non-linear filtering, etc).
   iv) decoded derived CCP mode.
   v) encoder selected CCP mode.
   vi) multi-model CCP mode.
   vii) single model CCP mode.
5) When a template-based method is used to determine the usage of a first low pass filter (e.g., LBCCP) for the current coding unit, the template samples may be filtered by a second low pass filter.
a) For example, one scenario of such case is that:
   i) for the CCP candidates reordering process for the current block, template costs are calculated for each candidate, wherein the template comprises of neighboring samples above and/or left to the current block, and a template cost is calculated by accumulating the SAD between a certain CCP model predicted values and reconstructed values of template samples. The CCP candidates reordering process is conducted based on the template costs comparison of all CCP candidates.
b) For example, the second low pass filter may be different from the first low pass filter.
   i) For example, if a certain CCP candidate of the current block is coded by a first low pass filter (e.g., LBCCP), the corresponding template cost for such CCP candidate may be calculated by applying a second low pass filter (rather than the first low pass filter) to the template samples.
   ii) Alternatively, the second low pass filter may be the sample as the first low pass filter.
c) For example, the second low pass filter applied to the template may access samples within the current template.
   i) For example, it may not access samples outside of the current template.
   ii) For example, for a horizontal (sub)template, by using the second low pass filter, each template sample may be filtered based on its horizontal neighboring samples.
   iii) For example, for a vertical (sub)template, by using the second low pass filter, each template sample may be filtered based on its vertical neighboring samples.
d) For example, the second low pass filter may be a N-tap filter (such as N=3).
   i) For example, [3,10,3]/16 filter may be used to each template sample.
   ii) For example, [1,2,1]/16 filter may be used to each template sample.
   iii) For example, the middle tap coefficient may be multiplied by the value of the sample to be calculated, and it may have the largest value among all coefficients.
   iv) For example, for a horizontal template, each template sample may be filtered based on its left neighbor sample, right neighbor sample, and the original value of such template sample.
   v) For example, for a vertical template, each template sample may be filtered based on its above neighbor sample, bottom neighbor sample, and the original value of such template sample.
e) For example, the current coding unit may be coded by:
   i) decoded derived CCP mode.
   ii) encoder selected CCP mode.
   iii) multi-model CCP mode.
   iv) single model CCP mode.
   v) an interCCP mode (e.g., interCCCM, interCCP, interCCPmerge, interCCPfusion, etc).
   vi) a non-CCP inter mode (e.g., inter merge, inter CIIP, inter GPM, GPM inter-intra, inter AMVP, inter amvp-merge, inter affine, etc.).
   vii) an intraCCP mode (e.g., intraCCCM, CCCM-MDF, GL-CCCM, NS-CCCM, GLM, CCLM, intraCCPmerge, intraCCPfusion, etc).
   viii) a non-CCP intra mode (e.g., filtered intra mode, filtered intraTMP, EFI filtered intra mode, BIF filtered intra mode, Hadamard filtered intra mode, regular intra mode, etc).
   ix) a filtered IBC mode.
   x) a regular IBC mode without linear/non-linear filtering.

### General Aspects:

1) The disclosed method may be used in single tree.
2) The disclosed method may be used in dual tree.
3) The disclosed method may be used for chroma coding.
4) The disclosed method may be used for luma coding.
5) The disclosed method may be used for intra block coding.
6) The disclosed method may be used for inter block coding.
7) The disclosed method may be used for IBC block coding.
8) The disclosed method may be used in a inter (such as B or P) slice.
9) The disclosed method may be used in an intra (such as I) slice.
10) Whether to and/or how to apply the disclosed methods above may be signalled at sequence level/group of pictures level/picture level/slice level/tile group level, such as in sequence header/picture header/SPSNPS/DPS/DCI/PPS/APS/slice header/tile group header.
11) Whether to and/or how to apply the disclosed methods above may be signalled at PB/TB/CB/PU/TU/CU/VPDU/CTU/CTU row/slice/tile/sub-picture/other kinds of region contain more than one sample or pixel.
12) Whether to and/or how to apply the disclosed methods above may be dependent on coded information, such as block size, colour format, single/dual tree partitioning, colour component, slice/picture type.

FIG. 34 illustrates a flowchart of a method 3400 for video processing in accordance with embodiments of the present disclosure. The method 3400 is implemented during a conversion between a video unit of a video and a bitstream of the video. As used herein, a video unit may be referred to as a video block or block. The conversion may include encoding the video unit into the bitstream and/or decoding the video unit from the bitstream.

At block 3410, for a conversion between a current video unit of a video and a bitstream of the video, an indicator of a low-pass filter of the current video unit is determined by inheriting from a previous coded block.

At block 3420, the low-pass filter is applied to the current video unit based on the indicator.

At block 3430, the conversion is performed based on the applying.

The method 3400 enables inheriting an indicator of a low-pass filter from a previous coded block, and thus improves the coding performance.

In some embodiments, the low-pass filter comprises a local-boosting cross-component prediction (LBCCP), and the indicator comprises an LBCCP flag.

In some embodiments, whether to apply the low-pass filter to the current video unit is inherited from the previous coded block.

In some embodiments, a coding mode of the current video unit comprises at least one of: an inter cross-component prediction (CCP) mode, a non-CCP inter mode, an intra CCP mode, a non-CCP intra mode, a filtered intra block copy (IBC) mode, a regular IBC mode without linear or non-linear filtering, a decoded derived CCP mode, an encoder selected CCP mode, a multi-model CCP mode, or a single model CCP mode.

In some embodiments, the inter CCP mode comprises at least one of: an inter convolutional cross-component model (CCCM) mode, an inter CCP merge mode, or an inter CCP fusion mode.

In some embodiments, the non-CCP inter mode comprises at least one of: an inter merge mode, an inter combined inter and intra prediction (CIIP) mode, a inter geometric partitioning mode (GPM), a GPM inter-intra mode, an inter advanced motion vector prediction (AMVP) mode, an inter AMVP merge mode, or an inter affine mode.

In some embodiments, the intra CCP mode comprises at least one of: an intra convolutional cross-component model (CCCM) mode, a CCCM-multi model dual filtering (CCCM-MDF) mode, a gradient and location based CCCM (GL-CCCM), a non-downsampled CCCM (NS-CCCM), a gradient linear model (GLM) mode, a convolutional cross-component learning model (CCLM) mode, an intra CCP merge mode, or an intra CCP fusion mode.

In some embodiments, the non-CCP intra mode comprises at least one of: a filtered intra mode, a filtered intra template matching prediction (intraTMP), an enhanced filtered intra (EFI) mode, a block-based filtered intra (BIF) mode, a Hadamard filtered intra mode, or a regular intra mode.

In some embodiments, the previous coded block comprises at least one of: a block in a current picture comprising the current video unit, or a block from a picture in a decoded picture buffer.

In some embodiments, the block in the current picture comprises at least one of: a spatial adjacent neighbor of the current video unit, a spatial non-adjacent neighbor of the current video unit, a candidate from a history-based table.

In some embodiments, the block from the picture in the decoded picture buffer comprises a temporal neighbor of the current video unit.

According to further embodiments of the present disclosure, a non-transitory computer-readable recording medium is provided. The non-transitory computer-readable recording medium stores a bitstream of a video which is generated by a method performed by an apparatus for video processing. In the method, an indicator of a low-pass filter of a current video unit of the video is determined by inheriting from a previous coded block. The low-pass filter is applied to the current video unit based on the indicator. The bitstream is generated based on the applying.

According to still further embodiments of the present disclosure, a method for storing bitstream of a video is provided. In the method, an indicator of a low-pass filter of a current video unit of the video is determined by inheriting from a previous coded block. The low-pass filter is applied to the current video unit based on the indicator. The bitstream is generated based on the applying. The bitstream is stored in a non-transitory computer-readable recording medium.

FIG. 35 illustrates a flowchart of a method 3500 for video processing in accordance with embodiments of the present disclosure. The method 3500 is implemented during a conversion between a video unit of a video and a bitstream of the video.

At block 3510, for a conversion between a current video unit of a video and a bitstream of the video, a low-pass filter is applied to the current video unit coded in a fusion mode.

At block 3520, the conversion is performed based on the applying.

The method 3500 enables applying the low-pass filter to filter a fusion mode coded current unit or block.

In some embodiments, the low-pass filter comprises a local-boosting cross-component prediction (LBCCP).

In some embodiments, applying the low-pass filter comprises: applying the low-pass filter to a fused prediction of the current video unit to obtain a final prediction of the current video unit, wherein the fused prediction is determined by fusing a first prediction and a second prediction of the current video unit.

In some embodiments, applying the low-pass filter comprises: applying the low-pass filter to a first prediction of the current video unit to obtain a filtered first prediction, wherein the method further comprises: fusing the filtered first prediction with a second prediction of the current video unit to obtain a final prediction of the current video unit.

In some embodiments, the current video unit is coded by at least one of: an intra mode, an inter mode, or an intra block copy (IBC) mode.

According to further embodiments of the present disclosure, a non-transitory computer-readable recording medium is provided. The non-transitory computer-readable recording medium stores a bitstream of a video which is generated by a method performed by an apparatus for video processing. In the method, a low-pass filter is applied to a current video unit of the video, the current video unit being coded in a fusion mode. The bitstream is generated based on the applying.

According to still further embodiments of the present disclosure, a method for storing bitstream of a video is provided. In the method, a low-pass filter is applied to a current video unit of the video, the current video unit being coded in a fusion mode. The bitstream is generated based on the applying. The bitstream is stored in a non-transitory computer-readable recording medium.

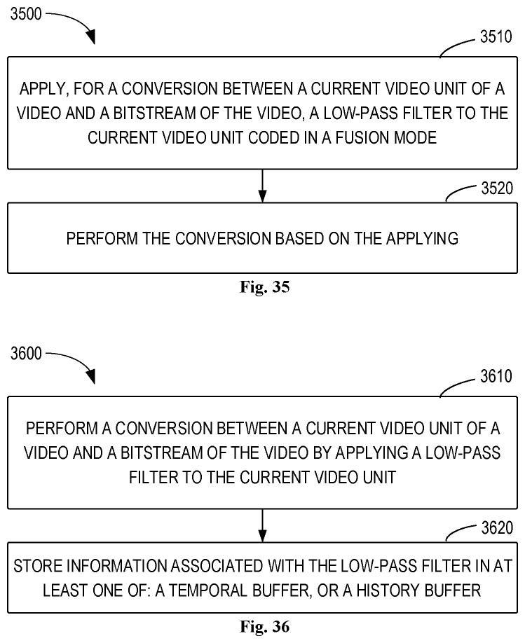

FIG. 36 illustrates a flowchart of a method 3600 for video processing in accordance with embodiments of the present disclosure. The method 3600 is implemented during a conversion between a video unit of a video and a bitstream of the video.

At block 3610, a conversion between a current video unit of a video and a bitstream of the video is performed by applying a low-pass filter to the current video unit.

At block 3620, information associated with the low-pass filter is stored in at least one of: a temporal buffer, or a history buffer.

The method 3600 enables storing information associated with the low-pass filter in the temporal buffer and/or history buffer for future usage.

In some embodiments, the low-pass filter comprises a local-boosting cross-component prediction (LBCCP).

In some embodiments, the information associated with the low-pass filter comprises an indicator of the low-pass filter.

In some embodiments, the method 3600 further comprises: applying the information associated with the low-pass filter in the temporal buffer for a further video unit in a further picture of the video.

In some embodiments, the further picture is coded after a current picture comprising the current video unit.

In some embodiments, the method 3600 further comprises: applying the information associated with the low-pass filter in the history buffer for a further video unit in a current picture comprising the current video unit, the further video unit being coded after the current video unit.

In some embodiments, a coding mode of the current video unit and/or the further coding unit comprises at least one of: an intra mode, an inter mode, an intra block copy (IBC) mode, a decoded derived cross-component prediction (CCP) mode, an encoder selected CCP mode, a multi-model CCP mode, or a single model CCP mode.

In some embodiments, the intra mode comprises at least one of: an intra convolutional cross-component model (CCCM) mode, a CCCM-multi model dual filtering (CCCM-MDF) mode, a gradient and location based CCCM (GL-CCCM), a non-downsampled CCCM (NS-CCCM), a gradient linear model (GLM) mode, a convolutional cross-component learning model (CCLM) mode, an intra CCP merge mode, a filtered intra mode, a filtered intra template matching prediction (intraTMP), an enhanced filtered intra (EFI) mode, a block-based filtered intra (BIF) mode, a Hadamard filtered intra mode, or a regular intra mode.

In some embodiments, the inter mode comprises at least one of: an inter convolutional cross-component model (CCCM) mode, an inter CCP mode, an inter CCP merge mode, a filtered inter mode, an inter merge mode, an inter combined inter and intra prediction (CIIP) mode, a inter geometric partitioning mode (GPM), a GPM inter-intra mode, an inter advanced motion vector prediction (AMVP) mode, an inter AMVP merge mode, or an inter affine mode.

In some embodiments, the IBC mode comprises at least one of: a filtered intra block copy (IBC) mode, or a regular IBC mode without linear or non-linear filtering.

According to further embodiments of the present disclosure, a non-transitory computer-readable recording medium is provided. The non-transitory computer-readable recording medium stores a bitstream of a video which is generated by a method performed by an apparatus for video processing. In the method, the bitstream is generated by applying a low-pass filter to a current video unit of the video. Information associated with the low-pass filter is stored in at least one of: a temporal buffer, or a history buffer.

According to still further embodiments of the present disclosure, a method for storing bitstream of a video is provided. In the method, the bitstream is generated by applying a low-pass filter to a current video unit of the video. Information associated with the low-pass filter is stored in at least one of: a temporal buffer, or a history buffer. The bitstream is stored in a non-transitory computer-readable recording medium.

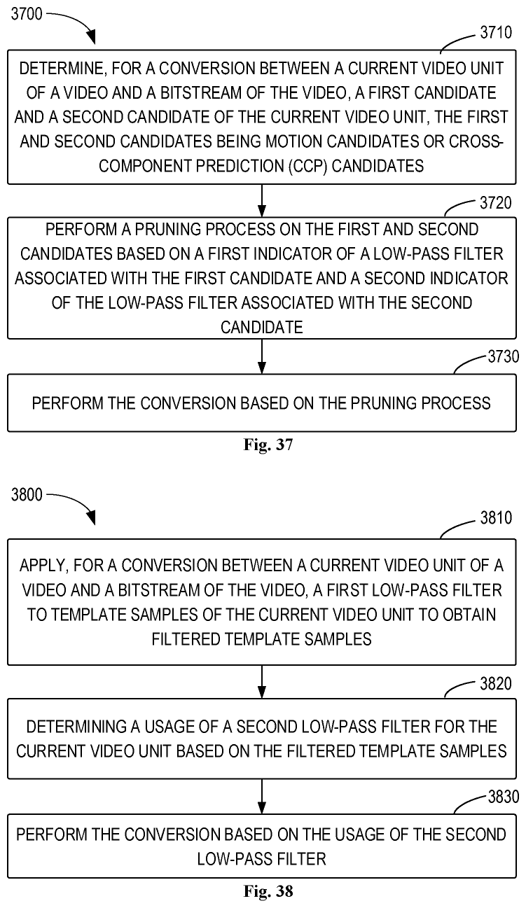

FIG. 37 illustrates a flowchart of a method 3700 for video processing in accordance with embodiments of the present disclosure. The method 3700 is implemented during a conversion between a video unit of a video and a bitstream of the video.

At block 3710, for a conversion between a current video unit of a video and a bitstream of the video, a first candidate and a second candidate of the current video unit are determined, the first and second candidates being motion candidates or cross-component prediction (CCP) candidates.

At block 3720, a pruning process is performed on the first and second candidates based on a first indicator of a low-pass filter associated with the first candidate and a second indicator of the low-pass filter associated with the second candidate. For example, a redundancy check may be performed on the first and second candidates based on the first and second indicators.

At block 3730, the conversion is performed based on the pruning process.

With the method 3700, if a redundancy check (or pruning process) is performed between motion/CCP candidates with and without low pass filter, the indicator of the low pass filter associated with the motion/CCP candidates may be considered.

In some embodiments, performing the pruning process comprises: in accordance with a determination that the fist indicator is different from the second indicator, determining that the first candidate is different from the second candidate.

In some embodiments, performing the pruning process comprises: in accordance with a determination that the fist indicator and the second indicator are same and first motion or CCP information of the first candidate is same with second motion or CCP information of the second candidate, determine that the first and second candidates are redundant. If two candidates are redundant, one of these two candidates may be removed or pruned.

In some embodiments, performing the pruning process comprises: in accordance with a determination that first motion or CCP information of the first candidate is same with second motion or CCP information of the second candidate, determine that the first and second candidates are redundant. If two candidates are redundant, one of these two candidates may be removed or pruned. In some embodiments, the first indicator is different from the second indicator.

In some embodiments, a coding mode of the current video unit comprises at least one of: an intra mode, an inter mode, an intra block copy (IBC) mode, a decoded derived cross-component prediction (CCP) mode, an encoder selected CCP mode, a multi-model CCP mode, or a single model CCP mode.

In some embodiments, the intra mode comprises at least one of: an intra convolutional cross-component model (CCCM) mode, a CCCM-multi model dual filtering (CCCM-MDF) mode, a gradient and location based CCCM (GL-CCCM), a non-downsampled CCCM (NS-CCCM), a gradient linear model (GLM) mode, a convolutional cross-component learning model (CCLM) mode, an intra CCP merge mode, a filtered intra mode, a filtered intra template matching prediction (intraTMP), an enhanced filtered intra (EFI) mode, a block-based filtered intra (BIF) mode, a Hadamard filtered intra mode, or a regular intra mode.

In some embodiments, the inter mode comprises at least one of: an inter convolutional cross-component model (CCCM) mode, an inter CCP mode, an inter CCP merge mode, a filtered inter mode, an inter merge mode, an inter combined inter and intra prediction (CIIP) mode, a inter geometric partitioning mode (GPM), a GPM inter-intra mode, an inter advanced motion vector prediction (AMVP) mode, an inter AMVP merge mode, or an inter affine mode.

In some embodiments, the IBC mode comprises at least one of: a filtered intra block copy (IBC) mode, or a regular IBC mode without linear or non-linear filtering.

In some embodiments, the low-pass filter comprises a local-boosting cross-component prediction (LBCCP).

According to further embodiments of the present disclosure, a non-transitory computer-readable recording medium is provided. The non-transitory computer-readable recording medium stores a bitstream of a video which is generated by a method performed by an apparatus for video processing. In the method, a first candidate and a second candidate of a current video unit of the video are determined, the first and second candidates being motion candidates or cross-component prediction (CCP) candidates. A pruning process is performed on the first and second candidates based on a first indicator of a low-pass filter associated with the first candidate and a second indicator of the low-pass filter associated with the second candidate. The bitstream is generated based on the pruning process.

According to still further embodiments of the present disclosure, a method for storing bitstream of a video is provided. In the method, a first candidate and a second candidate of a current video unit of the video are determined, the first and second candidates being motion candidates or cross-component prediction (CCP) candidates. A pruning process is performed on the first and second candidates based on a first indicator of a low-pass filter associated with the first candidate and a second indicator of the low-pass filter associated with the second candidate. The bitstream is generated based on the pruning process. The bitstream is stored in a non-transitory computer-readable recording medium.

FIG. 38 illustrates a flowchart of a method 3800 for video processing in accordance with embodiments of the present disclosure. The method 3800 is implemented during a conversion between a video unit of a video and a bitstream of the video.

At block 3810, for a conversion between a current video unit of a video and a bitstream of the video, a first low-pass filter is applied to template samples of the current video unit to obtain filtered template samples.

At block 3820, a usage of a second low-pass filter for the current video unit is determined based on the filtered template samples.

At block 3830, the conversion is performed based on the usage of the second low-pass filter.

With the method 3800, if a template-based method is used to determine the usage of a first low pass filter (e.g., LBCCP) for the current coding unit, the template samples may be filtered by a second low pass filter.

In some embodiments, the second low-pass filter comprises a local-boosting cross-component prediction (LBCCP).

In some embodiments, a template associated with the plurality of template costs comprises at least one of: a neighboring sample above to the current video unit, or a neighboring sample left to the current video unit; and performing a reordering process for the plurality of CCP candidates based on a comparison of the plurality of template costs.

In some embodiments, for a first CCP candidate of the plurality of CCP candidates, a first template cost of the first CCP candidate is determined based on a sum of absolute differences between predicted value obtained by the first CCP candidate and reconstructed values of the template samples.

In some embodiments, the first CCP candidate is coded by the second low-pass filter, and the first template cost is determined by applying the first low-pass filter to the template samples.

In some embodiments, the first low-pass filter is different from the second low-pass filter.

In some embodiments, the first low-pass filter is same with the second low-pass filter.

In some embodiments, the first low-pass filter applied to a template of the current video unit accesses samples within a current template of the current video unit.

In some embodiments, the first low-pass filter does not access samples outside the current template.

In some embodiments, for a horizontal template or sub-template, a template sample is filtered by the first low-pass filter based on horizontal neighboring samples of the horizontal template or sub-template.

In some embodiments, for a vertical template or sub-template, a template sample is filtered by the first low-pass filter based on vertical neighboring samples of the vertical template or sub-template.

In some embodiments, the first low-pass filter comprises a N-tap filter, N being a positive integer.

In some embodiments, coefficients of the first low-pass filter comprises [3,10,3]/16, or [1,2,1]/16, and the first low-pass filter with the coefficients is used for each template sample.

In some embodiments, a middle tap coefficient of the first low-pass filter is multiplied by a value of a sample to be calculated, and the middle tap coefficient is larger than other coefficients of the first low-pass filter.

In some embodiments, for a horizontal template of the current video unit, a template sample is filtered based on at least one of: a left neighbor sample of the template sample, a right neighbor sample of the template sample, or an original value of the template sample.

In some embodiments, for a vertical template of the current video unit, a template sample is filtered based on at least one of: an above neighbor sample of the template sample, a bottom neighbor sample of the template sample, or an original value of the template sample.

In some embodiments, the current video unit is coded by at least one of: a decoded derived cross-component prediction (CCP) mode, an encoder selected CCP mode, a multi-model CCP mode, a single model CCP mode, an inter CCP mode, a non-CCP inter mode, an intra CCP mode, a non-CCP intra mode, a filtered intra block copy (IBC) mode, or a regular IBC mode without linear or non-linear filtering.

In some embodiments, the inter CCP mode comprises at least one of: an inter convolutional cross-component model (CCCM) mode, an inter CCP merge mode, or an inter CCP fusion mode.

In some embodiments, the non-CCP inter mode comprises at least one of: an inter merge mode, an inter combined inter and intra prediction (CIIP) mode, a inter geometric partitioning mode (GPM), a GPM inter-intra mode, an inter advanced motion vector prediction (AMVP) mode, an inter AMVP merge mode, or an inter affine mode.

In some embodiments, the intra CCP mode comprises at least one of: an intra convolutional cross-component model (CCCM) mode, a CCCM-multi model dual filtering (CCCM-MDF) mode, a gradient and location based CCCM (GL-CCCM), a non-downsampled CCCM (NS-CCCM), a gradient linear model (GLM) mode, a convolutional cross-component learning model (CCLM) mode, an intra CCP merge mode, or an intra CCP fusion mode.

In some embodiments, the non-CCP intra mode comprises at least one of: a filtered intra mode, a filtered intra template matching prediction (intraTMP), an enhanced filtered intra (EFI) mode, a block-based filtered intra (BIF) mode, a Hadamard filtered intra mode, or a regular intra mode.

In some embodiments, the conversion comprises encoding the current video unit into the bitstream.

In some embodiments, the conversion comprises decoding the current video unit from the bitstream.

According to further embodiments of the present disclosure, a non-transitory computer-readable recording medium is provided. The non-transitory computer-readable recording medium stores a bitstream of a video which is generated by a method performed by an apparatus for video processing. In the method, a first low-pass filter is applied to template samples of a current video unit of the video to obtain filtered template samples. A usage of a second low-pass filter for the current video unit is determined based on the filtered template samples. The bitstream is generated based on the usage of the second low-pass filter.

According to still further embodiments of the present disclosure, a method for storing bitstream of a video is provided. In the method, a first low-pass filter is applied to template samples of a current video unit of the video to obtain filtered template samples. A usage of a second low-pass filter for the current video unit is determined based on the filtered template samples. The bitstream is generated based on the usage of the second low-pass filter. The bitstream is stored in a non-transitory computer-readable recording medium.

In some embodiments, the method 3400, the method 3500, the method 3600, the method 3700, and/or the method 3800 may be applied for at least one of: a single tree, or a dual tree.

In some embodiments, the method 3400, the method 3500, the method 3600, the method 3700, and/or the method 3800 may be applied for at least one of: a chroma coding, a luma coding, an intra block coding, an inter block coding, or an intra block copy (IBC) block coding.

In some embodiments, the method 3400, the method 3500, the method 3600, the method 3700, and/or the method 3800 may be used in at least one of: an inter slice, or an intra slice. In some embodiments, the inter slice comprises a B slice or a P slice, and the intra slice comprises an I slice.

In some embodiments, an indication of whether to and/or how to apply the method 3400, the method 3500, the method 3600, the method 3700, and/or the method 3800 may be indicated at one of: sequence level, group of pictures level, picture level, slice level, or tile group level.

In some embodiments, an indication of whether to and/or how to apply the method 3400, the method 3500, the method 3600, the method 3700, and/or the method 3800 may be indicated in one of: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, an indication of whether to and/or how to apply the method 3400, the method 3500, the method 3600, the method 3700, and/or the method 3800 may be included in one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, the method 3800 further comprises: determining, based on coded information of the current video unit, whether to and/or how to apply the method 3400, the method 3500, the method 3600, the method 3700, and/or the method 3800, the coded information comprising at least one of: a block size, a color format, a single and/or dual tree partitioning, a color component, a slice type, or a picture type.

It is to be understood that the method 3400 and/or the method 3500 and/or the method 3600 and/or the method 3700 and/or the method 3800 can be applied separately, or in any combination. With these methods, the coding efficiency and coding effectiveness can be improved.

Implementations of the present disclosure can be described in view of the following clauses, the features of which can be combined in any reasonable manner.

Clause 1. A method for video processing, comprising: determining, for a conversion between a current video unit of a video and a bitstream of the video, an indicator of a low-pass filter of the current video unit by inheriting from a previous coded block; applying the low-pass filter to the current video unit based on the indicator; and performing the conversion based on the applying.

Clause 2. The method of clause 1, wherein the low-pass filter comprises a local-boosting cross-component prediction (LBCCP), and the indicator comprises an LBCCP flag.

Clause 3. The method of clause 1 or 2, wherein whether to apply the low-pass filter to the current video unit is inherited from the previous coded block.

Clause 4. The method of any of clauses 1-3, wherein a coding mode of the current video unit comprises at least one of: an inter cross-component prediction (CCP) mode, a non-CCP inter mode, an intra CCP mode, a non-CCP intra mode, a filtered intra block copy (IBC) mode, a regular IBC mode without linear or non-linear filtering, a decoded derived CCP mode, an encoder selected CCP mode, a multi-model CCP mode, or a single model CCP mode.

Clause 5. The method of clause 4, wherein the inter CCP mode comprises at least one of: an inter convolutional cross-component model (CCCM) mode, an inter CCP merge mode, or an inter CCP fusion mode.

Clause 6. The method of clause 4, wherein the non-CCP inter mode comprises at least one of: an inter merge mode, an inter combined inter and intra prediction (CIIP) mode, a inter geometric partitioning mode (GPM), a GPM inter-intra mode, an inter advanced motion vector prediction (AMVP) mode, an inter AMVP merge mode, or an inter affine mode.

Clause 7. The method of clause 4, wherein the intra CCP mode comprises at least one of: an intra convolutional cross-component model (CCCM) mode, a CCCM-multi model dual filtering (CCCM-MDF) mode, a gradient and location based CCCM (GL-CCCM), a non-downsampled CCCM (NS-CCCM), a gradient linear model (GLM) mode, a convolutional cross-component learning model (CCLM) mode, an intra CCP merge mode, or an intra CCP fusion mode.

Clause 8. The method of clause 4, wherein the non-CCP intra mode comprises at least one of: a filtered intra mode, a filtered intra template matching prediction (intraTMP), an enhanced filtered intra (EFI) mode, a block-based filtered intra (BIF) mode, a Hadamard filtered intra mode, or a regular intra mode.

Clause 9. The method of any of clauses 1-8, wherein the previous coded block comprises at least one of: a block in a current picture comprising the current video unit, or a block from a picture in a decoded picture buffer.

Clause 10. The method of clause 9, wherein the block in the current picture comprises at least one of: a spatial adjacent neighbor of the current video unit, a spatial non-adjacent neighbor of the current video unit, a candidate from a history-based table.

Clause 11. The method of clause 9, wherein the block from the picture in the decoded picture buffer comprises a temporal neighbor of the current video unit.

Clause 12. A method for video processing, comprising: applying, for a conversion between a current video unit of a video and a bitstream of the video, a low-pass filter to the current video unit coded in a fusion mode; and performing the conversion based on the applying.

Clause 13. The method of clause 12, wherein the low-pass filter comprises a local-boosting cross-component prediction (LBCCP).

Clause 14. The method of clause 12 or 13, wherein applying the low-pass filter comprises: applying the low-pass filter to a fused prediction of the current video unit to obtain a final prediction of the current video unit, wherein the fused prediction is determined by fusing a first prediction and a second prediction of the current video unit.

Clause 15. The method of clause 12 or 13, wherein applying the low-pass filter comprises: applying the low-pass filter to a first prediction of the current video unit to obtain a filtered first prediction, wherein the method further comprises: fusing the filtered first prediction with a second prediction of the current video unit to obtain a final prediction of the current video unit.

Clause 16. The method of any of clauses 12-15, wherein the current video unit is coded by at least one of: an intra mode, an inter mode, or an intra block copy (IBC) mode.

Clause 17. A method for video processing, comprising: performing a conversion between a current video unit of a video and a bitstream of the video by applying a low-pass filter to the current video unit; and storing information associated with the low-pass filter in at least one of: a temporal buffer, or a history buffer.

Clause 18. The method of clause 17, wherein the low-pass filter comprises a local-boosting cross-component prediction (LBCCP).

Clause 19. The method of clause 17 or 18, wherein the information associated with the low-pass filter comprises an indicator of the low-pass filter.

Clause 20. The method of any of clauses 17-19, further comprising: applying the information associated with the low-pass filter in the temporal buffer for a further video unit in a further picture of the video.

Clause 21. The method of clause 20, wherein the further picture is coded after a current picture comprising the current video unit.

Clause 22. The method of any of clauses 17-19, further comprising: applying the information associated with the low-pass filter in the history buffer for a further video unit in a current picture comprising the current video unit, the further video unit being coded after the current video unit.

Clause 23. The method of any of clauses 20-22, wherein a coding mode of the current video unit and/or the further coding unit comprises at least one of: an intra mode, an inter mode, an intra block copy (IBC) mode, a decoded derived cross-component prediction (CCP) mode, an encoder selected CCP mode, a multi-model CCP mode, or a single model CCP mode.

Clause 24. The method of clause 23, wherein the intra mode comprises at least one of: an intra convolutional cross-component model (CCCM) mode, a CCCM-multi model dual filtering (CCCM-MDF) mode, a gradient and location based CCCM (GL-CCCM), a non-downsampled CCCM (NS-CCCM), a gradient linear model (GLM) mode, a convolutional cross-component learning model (CCLM) mode, an intra CCP merge mode, a filtered intra mode, a filtered intra template matching prediction (intraTMP), an enhanced filtered intra (EFI) mode, a block-based filtered intra (BIF) mode, a Hadamard filtered intra mode, or a regular intra mode.

Clause 25. The method of clause 23, wherein the inter mode comprises at least one of: an inter convolutional cross-component model (CCCM) mode, an inter CCP mode, an inter CCP merge mode, a filtered inter mode, an inter merge mode, an inter combined inter and intra prediction (CIIP) mode, a inter geometric partitioning mode (GPM), a GPM inter-intra mode, an inter advanced motion vector prediction (AMVP) mode, an inter AMVP merge mode, or an inter affine mode.

Clause 26. The method of clause 23, wherein the IBC mode comprises at least one of: a filtered intra block copy (IBC) mode, or a regular IBC mode without linear or non-linear filtering.

Clause 27. A method for video processing, comprising: determining, for a conversion between a current video unit of a video and a bitstream of the video, a first candidate and a second candidate of the current video unit, the first and second candidates being motion candidates or cross-component prediction (CCP) candidates; performing a pruning process on the first and second candidates based on a first indicator of a low-pass filter associated with the first candidate and a second indicator of the low-pass filter associated with the second candidate; and performing the conversion based on the pruning process.

Clause 28. The method of clause 27, wherein performing the pruning process comprises: in accordance with a determination that the fist indicator is different from the second indicator, determining that the first candidate is different from the second candidate.

Clause 29. The method of clause 27, wherein performing the pruning process comprises: in accordance with a determination that the fist indicator and the second indicator are same and first motion or CCP information of the first candidate is same with second motion or CCP information of the second candidate, determine that the first and second candidates are redundant.

Clause 30. The method of clause 27, wherein performing the pruning process comprises: in accordance with a determination that first motion or CCP information of the first candidate is same with second motion or CCP information of the second candidate, determine that the first and second candidates are redundant.

Clause 31. The method of clause 30, wherein the first indicator is different from the second indicator.

Clause 32. The method of any of clauses 27-31, wherein a coding mode of the current video unit comprises at least one of: an intra mode, an inter mode, an intra block copy (IBC) mode, a decoded derived cross-component prediction (CCP) mode, an encoder selected CCP mode, a multi-model CCP mode, or a single model CCP mode.

Clause 33. The method of clause 32, wherein the intra mode comprises at least one of: an intra convolutional cross-component model (CCCM) mode, a CCCM-multi model dual filtering (CCCM-MDF) mode, a gradient and location based CCCM (GL-CCCM), a non-downsampled CCCM (NS-CCCM), a gradient linear model (GLM) mode, a convolutional cross-component learning model (CCLM) mode, an intra CCP merge mode, a filtered intra mode, a filtered intra template matching prediction (intraTMP), an enhanced filtered intra (EFI) mode, a block-based filtered intra (BIF) mode, a Hadamard filtered intra mode, or a regular intra mode.

Clause 34. The method of clause 32, wherein the inter mode comprises at least one of: an inter convolutional cross-component model (CCCM) mode, an inter CCP mode, an inter CCP merge mode, a filtered inter mode, an inter merge mode, an inter combined inter and intra prediction (CIIP) mode, a inter geometric partitioning mode (GPM), a GPM inter-intra mode, an inter advanced motion vector prediction (AMVP) mode, an inter AMVP merge mode, or an inter affine mode.

Clause 35. The method of clause 32, wherein the IBC mode comprises at least one of: a filtered intra block copy (IBC) mode, or a regular IBC mode without linear or non-linear filtering.

Clause 36. The method of any of clauses 27-35, wherein the low-pass filter comprises a local-boosting cross-component prediction (LBCCP).

Clause 37. A method for video processing, comprising: applying, for a conversion between a current video unit of a video and a bitstream of the video, a first low-pass filter to template samples of the current video unit to obtain filtered template samples; determining a usage of a second low-pass filter for the current video unit based on the filtered template samples; and performing the conversion based on the usage of the second low-pass filter.

Clause 38. The method of clause 37, wherein the second low-pass filter comprises a local-boosting cross-component prediction (LBCCP).

Clause 39. The method of clause 37 or 38, further comprising: determining a plurality of template costs of a plurality of cross-component prediction (CCP) candidates of the current video unit based on the filtered template samples, wherein a template associated with the plurality of template costs comprises at least one of: a neighboring sample above to the current video unit, or a neighboring sample left to the current video unit; and performing a reordering process for the plurality of CCP candidates based on a comparison of the plurality of template costs.

Clause 40. The method of clause 39, wherein for a first CCP candidate of the plurality of CCP candidates, a first template cost of the first CCP candidate is determined based on a sum of absolute differences between predicted value obtained by the first CCP candidate and reconstructed values of the template samples.

Clause 41. The method of clause 40, wherein the first CCP candidate is coded by the second low-pass filter, and the first template cost is determined by applying the first low-pass filter to the template samples.

Clause 42. The method of any of clauses 37-41, wherein the first low-pass filter is different from the second low-pass filter.

Clause 43. The method of any of clauses 37-41, wherein the first low-pass filter is same with the second low-pass filter.

Clause 44. The method of any of clauses 37-43, wherein the first low-pass filter applied to a template of the current video unit accesses samples within a current template of the current video unit.

Clause 45. The method of clause 44, wherein the first low-pass filter does not access samples outside the current template.

Clause 46. The method of clause 44 or 45, wherein for a horizontal template or sub-template, a template sample is filtered by the first low-pass filter based on horizontal neighboring samples of the horizontal template or sub-template.

Clause 47. The method of clause 44 or 45, wherein for a vertical template or sub-template, a template sample is filtered by the first low-pass filter based on vertical neighboring samples of the vertical template or sub-template.

Clause 48. The method of any of clauses 39-47, wherein the first low-pass filter comprises a N-tap filter, N being a positive integer.

Clause 49. The method of clause 48, wherein coefficients of the first low-pass filter comprises [3,10,3]/16, or [1,2,1]/16, and the first low-pass filter with the coefficients is used for each template sample.

Clause 50. The method of clause 48, wherein a middle tap coefficient of the first low-pass filter is multiplied by a value of a sample to be calculated, and the middle tap coefficient is larger than other coefficients of the first low-pass filter.

Clause 51. The method of any of clauses 39-50, wherein for a horizontal template of the current video unit, a template sample is filtered based on at least one of: a left neighbor sample of the template sample, a right neighbor sample of the template sample, or an original value of the template sample.

Clause 52. The method of any of clauses 39-51, wherein for a vertical template of the current video unit, a template sample is filtered based on at least one of: an above neighbor sample of the template sample, a bottom neighbor sample of the template sample, or an original value of the template sample.

Clause 53. The method of any of clauses 39-52, wherein the current video unit is coded by at least one of: a decoded derived cross-component prediction (CCP) mode, an encoder selected CCP mode, a multi-model CCP mode, a single model CCP mode, an inter CCP mode, a non-CCP inter mode, an intra CCP mode, a non-CCP intra mode, a filtered intra block copy (IBC) mode, or a regular IBC mode without linear or non-linear filtering.

Clause 54. The method of clause 53, wherein the inter CCP mode comprises at least one of: an inter convolutional cross-component model (CCCM) mode, an inter CCP merge mode, or an inter CCP fusion mode.

Clause 55. The method of clause 53, wherein the non-CCP inter mode comprises at least one of: an inter merge mode, an inter combined inter and intra prediction (CIIP) mode, a inter geometric partitioning mode (GPM), a GPM inter-intra mode, an inter advanced motion vector prediction (AMVP) mode, an inter AMVP merge mode, or an inter affine mode.

Clause 56. The method of clause 53, wherein the intra CCP mode comprises at least one of: an intra convolutional cross-component model (CCCM) mode, a CCCM-multi model dual filtering (CCCM-MDF) mode, a gradient and location based CCCM (GL-CCCM), a non-downsampled CCCM (NS-CCCM), a gradient linear model (GLM) mode, a convolutional cross-component learning model (CCLM) mode, an intra CCP merge mode, or an intra CCP fusion mode.

Clause 57. The method of clause 53, wherein the non-CCP intra mode comprises at least one of: a filtered intra mode, a filtered intra template matching prediction (intraTMP), an enhanced filtered intra (EFI) mode, a block-based filtered intra (BIF) mode, a Hadamard filtered intra mode, or a regular intra mode.

Clause 58. The method of any of clauses 1-57, wherein the method is applied for at least one of: a single tree, or a dual tree.

Clause 59. The method of any of clauses 1-58, wherein the method is applied for at least one of: a chroma coding, a luma coding, an intra block coding, an inter block coding, or an intra block copy (IBC) block coding.

Clause 60. The method of any of clauses 1-59, wherein the method is used in at least one of: an inter slice, or an intra slice.

Clause 61. The method of clause 60, wherein the inter slice comprises a B slice or a P slice, and the intra slice comprises an I slice.

Clause 62. The method of any of clauses 1-61, wherein an indication of whether to and/or how to apply the method is indicated at one of: sequence level, group of pictures level, picture level, slice level, or tile group level.

Clause 63. The method of any of clauses 1-62, wherein an indication of whether to and/or how to apply the method is indicated in one of: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 64. The method of any of clauses 1-63, wherein an indication of whether to and/or how to apply the method is included in one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 65. The method of any of clauses 1-61, further comprising: determining, based on coded information of the current video unit, whether to and/or how to apply the method, the coded information comprising at least one of: a block size, a color format, a single and/or dual tree partitioning, a color component, a slice type, or a picture type.

Clause 66. The method of any of clauses 1-65, wherein the conversion comprises encoding the current video unit into the bitstream.

Clause 67. The method of any of clauses 1-65, wherein the conversion comprises decoding the current video unit from the bitstream.

Clause 68. An apparatus for video processing comprising a processor and a non-transitory memory with instructions thereon, wherein the instructions upon execution by the processor, cause the processor to perform a method in accordance with any of clauses 1-67.

Clause 69. A non-transitory computer-readable storage medium storing instructions that cause a processor to perform a method in accordance with any of clauses 1-67.

Clause 70. A non-transitory computer-readable recording medium storing a bitstream of a video which is generated by a method performed by an apparatus for video processing, wherein the method comprises: determining an indicator of a low-pass filter of a current video unit of the video by inheriting from a previous coded block; applying the low-pass filter to the current video unit based on the indicator; and generating the bitstream based on the applying.

Clause 71. A method for storing a bitstream of a video, comprising: determining an indicator of a low-pass filter of a current video unit of the video by inheriting from a previous coded block; applying the low-pass filter to the current video unit based on the indicator; generating the bitstream based on the applying; and storing the bitstream in a non-transitory computer-readable recording medium.

Clause 72. A non-transitory computer-readable recording medium storing a bitstream of a video which is generated by a method performed by an apparatus for video processing, wherein the method comprises: applying a low-pass filter to a current video unit of the video, the current video unit being coded in a fusion mode; and generating the bitstream based on the applying.

Clause 73. A method for storing a bitstream of a video, comprising: applying a low-pass filter to a current video unit of the video, the current video unit being coded in a fusion mode; generating the bitstream based on the applying; and storing the bitstream in a non-transitory computer-readable recording medium.

Clause 74. A non-transitory computer-readable recording medium storing a bitstream of a video which is generated by a method performed by an apparatus for video processing, wherein the method comprises: generating the bitstream by applying a low-pass filter to a current video unit of the video; and storing information associated with the low-pass filter in at least one of: a temporal buffer, or a history buffer.

Clause 75. A method for storing a bitstream of a video, comprising: generating the bitstream by applying a low-pass filter to a current video unit of the video; storing information associated with the low-pass filter in at least one of: a temporal buffer, or a history buffer; and storing the bitstream in a non-transitory computer-readable recording medium.

Clause 76. A non-transitory computer-readable recording medium storing a bitstream of a video which is generated by a method performed by an apparatus for video processing, wherein the method comprises: determining a first candidate and a second candidate of a current video unit of the video, the first and second candidates being motion candidates or cross-component prediction (CCP) candidates; performing a pruning process on the first and second candidates based on a first indicator of a low-pass filter associated with the first candidate and a second indicator of the low-pass filter associated with the second candidate; and generating the bitstream based on the pruning process.

Clause 77. A method for storing a bitstream of a video, comprising: determining a first candidate and a second candidate of a current video unit of the video, the first and second candidates being motion candidates or cross-component prediction (CCP) candidates; performing a pruning process on the first and second candidates based on a first indicator of a low-pass filter associated with the first candidate and a second indicator of the low-pass filter associated with the second candidate; generating the bitstream based on the pruning process; and storing the bitstream in a non-transitory computer-readable recording medium.

Clause 78. A non-transitory computer-readable recording medium storing a bitstream of a video which is generated by a method performed by an apparatus for video processing, wherein the method comprises: applying a first low-pass filter to template samples of a current video unit of the video to obtain filtered template samples; determining a usage of a second low-pass filter for the current video unit based on the filtered template samples; and generating the bitstream based on the usage of the second low-pass filter.

Clause 79. A method for storing a bitstream of a video, comprising: applying a first low-pass filter to template samples of a current video unit of the video to obtain filtered template samples; determining a usage of a second low-pass filter for the current video unit based on the filtered template samples; generating the bitstream based on the usage of the second low-pass filter; and storing the bitstream in a non-transitory computer-readable recording medium.

### Example Device

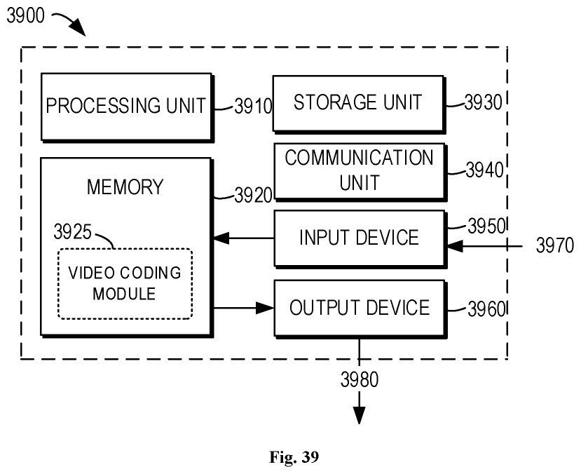

FIG. 39 illustrates a block diagram of a computing device 3900 in which various embodiments of the present disclosure can be implemented. The computing device 3900 may be implemented as or included in the source device 110 (or the video encoder 114 or 200) or the destination device 120 (or the video decoder 124 or 300).

It would be appreciated that the computing device 3900 shown in FIG. 39 is merely for purpose of illustration, without suggesting any limitation to the functions and scopes of the embodiments of the present disclosure in any manner.

As shown in FIG. 39, the computing device 3900 includes a general-purpose computing device 3900. The computing device 3900 may at least comprise one or more processors or processing units 3910, a memory 3920, a storage unit 3930, one or more communication units 3940, one or more input devices 3950, and one or more output devices 3960.

In some embodiments, the computing device 3900 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 3900 can support any type of interface to a user (such as “wearable” circuitry and the like).

The processing unit 3910 may be a physical or virtual processor and can implement various processes based on programs stored in the memory 3920. In a multi-processor system, multiple processing units execute computer executable instructions in parallel so as to improve the parallel processing capability of the computing device 3900. The processing unit 3910 may also be referred to as a central processing unit (CPU), a microprocessor, a controller or a microcontroller.

The computing device 3900 typically includes various computer storage medium. Such medium can be any medium accessible by the computing device 3900, including, but not limited to, volatile and non-volatile medium, or detachable and non-detachable medium. The memory 3920 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 3930 may be any detachable or non-detachable medium and may include a machine-readable medium such as a memory, flash memory drive, magnetic disk or another other media, which can be used for storing information and/or data and can be accessed in the computing device 3900.

The computing device 3900 may further include additional detachable/non-detachable, volatile/non-volatile memory medium. Although not shown in FIG. 39, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 3940 communicates with a further computing device via the communication medium. In addition, the functions of the components in the computing device 3900 can be implemented by a single computing cluster or multiple computing machines that can communicate via communication connections. Therefore, the computing device 3900 can operate in a networked environment using a logical connection with one or more other servers, networked personal computers (PCs) or further general network nodes.

The input device 3950 may be one or more of a variety of input devices, such as a mouse, keyboard, tracking ball, voice-input device, and the like. The output device 3960 may be one or more of a variety of output devices, such as a display, loudspeaker, printer, and the like. By means of the communication unit 3940, the computing device 3900 can further communicate with one or more external devices (not shown) such as the storage devices and display device, with one or more devices enabling the user to interact with the computing device 3900, or any devices (such as a network card, a modem and the like) enabling the computing device 3900 to communicate with one or more other computing devices, if required. Such communication can be performed via input/output (I/O) interfaces (not shown).

In some embodiments, instead of being integrated in a single device, some or all components of the computing device 3900 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 3900 may be used to implement video encoding/decoding in embodiments of the present disclosure. The memory 3920 may include one or more video coding modules 3925 having one or more program instructions. These modules are accessible and executable by the processing unit 3910 to perform the functionalities of the various embodiments described herein.

In the example embodiments of performing video encoding, the input device 3950 may receive video data as an input 3970 to be encoded. The video data may be processed, for example, by the video coding module 3925, to generate an encoded bitstream. The encoded bitstream may be provided via the output device 3960 as an output 3980.

In the example embodiments of performing video decoding, the input device 3950 may receive an encoded bitstream as the input 3970. The encoded bitstream may be processed, for example, by the video coding module 3925, to generate decoded video data. The decoded video data may be provided via the output device 3960 as the output 3980.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

What is claimed is:

1. A method for video processing, comprising:
determining, for a conversion between a current video unit of a video and a bitstream of the video, an indicator of a low-pass filter of the current video unit by inheriting from a previous coded block;
applying the low-pass filter to the current video unit based on the indicator; and
performing the conversion based on the applying.

2. The method of claim 1, wherein the low-pass filter comprises a local-boosting cross-component prediction (LBCCP), and the indicator comprises an LBCCP flag.

3. The method of claim 1, wherein whether to apply the low-pass filter to the current video unit is inherited from the previous coded block.

4. The method of claim 1, wherein a coding mode of the current video unit comprises at least one of:
an inter cross-component prediction (CCP) mode,
a non-CCP inter mode,
an intra CCP mode,
a non-CCP intra mode,
a filtered intra block copy (IBC) mode,
a regular IBC mode without linear or non-linear filtering,
a decoded derived CCP mode,
an encoder selected CCP mode,
a multi-model CCP mode, or
a single model CCP mode.

5. The method of claim 4, wherein the inter CCP mode comprises at least one of: an inter convolutional cross-component model (CCCM) mode, an inter CCP merge mode, or an inter CCP fusion mode.

6. The method of claim 4, wherein the non-CCP inter mode comprises at least one of: an inter merge mode, an inter combined inter and intra prediction (CIIP) mode, a inter geometric partitioning mode (GPM), a GPM inter-intra mode, an inter advanced motion vector prediction (AMVP) mode, an inter AMVP merge mode, or an inter affine mode.

7. The method of claim 4, wherein the intra CCP mode comprises at least one of: an intra convolutional cross-component model (CCCM) mode, a CCCM-multi model dual filtering (CCCM-MDF) mode, a gradient and location based CCCM (GL-CCCM), a non-downsampled CCCM (NS-CCCM), a gradient linear model (GLM) mode, a convolutional cross-component learning model (CCLM) mode, an intra CCP merge mode, or an intra CCP fusion mode.

8. The method of claim 4, wherein the non-CCP intra mode comprises at least one of: a filtered intra mode, a filtered intra template matching prediction (intraTMP), an enhanced filtered intra (EFI) mode, a block-based filtered intra (BIF) mode, a Hadamard filtered intra mode, or a regular intra mode.

9. The method of claim 1, wherein the previous coded block comprises at least one of: a block in a current picture comprising the current video unit, or a block from a picture in a decoded picture buffer.

10. The method of claim 9, wherein the block in the current picture comprises at least one of:
a spatial adjacent neighbor of the current video unit,
a spatial non-adjacent neighbor of the current video unit, or
a candidate from a history-based table.

11. The method of claim 9, wherein the block from the picture in the decoded picture buffer comprises a temporal neighbor of the current video unit.

12. The method of claim 1, wherein the low-pass filter is applied to the current video unit coded in a fusion mode.

13. The method of claim 12, wherein applying the low-pass filter comprises:
applying the low-pass filter to a fused prediction of the current video unit to obtain a final prediction of the current video unit, wherein the fused prediction is determined by fusing a first prediction and a second prediction of the current video unit.

14. The method of claim 12, wherein applying the low-pass filter comprises:
applying the low-pass filter to a first prediction of the current video unit to obtain a filtered first prediction,
wherein the method further comprises: fusing the filtered first prediction with a second prediction of the current video unit to obtain a final prediction of the current video unit.

15. The method of claim 12, wherein the current video unit is coded by at least one of: an intra mode, an inter mode, or an intra block copy (IBC) mode.

16. The method of claim 1, wherein the conversion comprises encoding the current video unit into the bitstream.

17. The method of claim 1, wherein the conversion comprises decoding the current video unit from the bitstream.

18. The method of claim 1, wherein the conversion comprises: generating the bitstream from the video, and
the method further comprises: storing the bitstream in a non-transitory computer-readable recording medium.

19. An apparatus for video processing comprising a processor and a non-transitory memory with instructions thereon, wherein the instructions upon execution by the processor, cause the processor to:
determine, for a conversion between a current video unit of a video and a bitstream of the video, an indicator of a low-pass filter of the current video unit by inheriting from a previous coded block;
apply the low-pass filter to the current video unit based on the indicator; and
perform the conversion based on the applying.

20. A non-transitory computer-readable storage medium storing instructions that cause a processor to perform operations comprising:
determining, for a conversion between a current video unit of a video and a bitstream of the video, an indicator of a low-pass filter of the current video unit by inheriting from a previous coded block;
applying the low-pass filter to the current video unit based on the indicator; and
performing the conversion based on the applying.
